(19) United States
(12) Patent Application Publication
(10) Pub. No.: US 2024/0193501 A1
(43) Pub. Date: Jun. 13, 2024

(54) INTERFACE FOR MANAGEMENT OF RESOURCE TRANSFERS

(71) Applicant: Truist Bank, Charlotte, NC (US)

(72) Inventors: Candice Mercer Roberts, Harrisburg, NC (US); Randy Eric Borth, Concord, NC (US); Ashok Kumar Mittal, Charlotte, NC (US); Surendra Nath Puduru, Raleigh, NC (US); WeiJen Lu, Raleigh, NC (US); Natalie Renee Stormer, Raleigh, NC (US); Reinaldo Gamaliel Rivera Colon, Raleigh, NC (US); Kelly Mosby Griffin, Matthews, NC (US); Jennifer Meredith Merten, Brookhaven, GA (US); Mary Margaret Mueller, Charlotte, NC (US)

(73) Assignee: Truist Bank, Charlotte, NC (US)

(21) Appl. No.: 18/063,279

(22) Filed: Dec. 8, 2022

(51) Int. Cl. G06Q 10/0631; G06F 9/451; G06N 3/098

(52) U.S. Cl. CPC G06Q 10/0631; G06F 9/451; G06N 3/098

(57) ABSTRACT

Disclosed are systems and methods that automate management and monitoring of remote resource utilization activity. The systems process incoming transfer instructions, data relating to prior resource transfers, and data relating to end user attributes and activities to generate notifications concerning relevant current transfer activity, expected future transfers, and modifications to optimize ongoing resource utilization and transfer activity. The systems allow resource utilization to be managed effectively, efficiently, and in a secure fashion using encryption and individual computing device authentication techniques.

### TECHNICAL FIELD AND BACKGROUND

The present invention relates generally to the field of effective and efficient management of resource utilization, and more particularly, systems and methods that utilize artificial intelligence technology to process resource transfer data and generate user notifications of relevant conditions in current resource transfer activity, predicted resource transfer activity, and modifications to optimize resource utilization, as well as graphical user interfaces that facilitate monitoring and management of resource transfer activity.

Individual users generally seek to monitor and manage resource transfer activity over time to ensure future resource requirements are met effectively and efficiently. Monitoring and managing resource transfer activity, however, can be time consuming and challenging. Resource transfers typically occur over significant time periods, are distributed across multiple locations, are dedicated for varying purposes, and involve generation of substantial amounts of data. Resource transfers must be frequently monitored, and lapses in monitoring typically result in over-utilization errors and inefficient resource utilization. Further, resource requirements are typically dynamic and change over time such that flat, static monitoring metrics do not accommodate the needs of individual systems users.

To address the drawbacks of traditional techniques for managing resource utilization, disclosed herein are systems and methods that automate the analysis of resource transfer activity and that generate notifications concerning relevant current resource transfer activity, expected future resource transfers, and modifications to optimize ongoing resource utilization and transfer activity. The systems further allow resource utilization to be managed effectively, efficiently, and in a secure fashion using encryption and individual computing device authentication techniques.

### SUMMARY

According to one embodiment, a system for processing transfer data includes a network computing device, such as a server, that is operated by a provider. The system also includes a user computing device that is used to initiate resource transfer transactions (e.g., payments), such as a personal computer, cellular smart phone, or a “smart card” that includes an integrated microprocessor, memory, and software. The system can further include a second user computing device that interfaces with the provider's computing system to navigate through various graphical interfaces to manage and monitor resource utilization. The system further includes a terminal computing device operated by a third party and that interacts with the user computing device to implement a resource transfer transaction. The network computing device, terminal computing device, and user computing device each comprise one or more integrated software applications that perform operations to implement the current technology.

As part of processing a transfer instruction, the user computing device and/or the user must be verified to ensure authenticity and security. The terminal computing device verifies the user computing device by receiving a certificate of authority from the user computing device that is encrypted using an encryption key stored by the user computing device. The terminal computing device decodes, or decrypts, the certificate authority using a public key, and the resulting data, called a received device identification, can be confirmed by comparison to known values for the received device identification.

Once verified, the system generates a transfer instruction, which is a request to utilize resources as part of a transaction between the user and the third party administering or operating the terminal computing device. The transfer instruction includes transfer value data (i.e., a quantitative measure of resources that are the subject of the transfer instruction), sequencing data (i.e., a time and date corresponding to the transfer instruction or that otherwise indicates the sequence of when a transfer instruction was received or generated relative to other transfer instructions), and product identification data (i.e., a user account number where the account represents a product administered by the provider).

The transfer instruction is transmitted to the provider network computing device, which passes product identification data from the transfer instruction to a Transfer Activity Database. In return, a Transfer Monitor software service (or another software application integrated with the network computing device) receives transfer data relating to a plurality of transfers that are associated with the product identification data.

The provider computing device performs a transfer analysis utilizing the transfer instruction and the transfer data. The transfer analysis processes the transfer data and transfer instructions to recognize specified conditions and to generate relevant insights for review by the user that relate to the transactions represented by the transfer instructions. The transfer analysis generates a product utilization message that includes utilization value data (e.g., an amount or quantity of resources subject to a transfer) and message sequencing data (i.e., a date and time of a resource transfer).

The provider computing device optionally performs a priority analysis that processes the product utilization message to generate priority data that represents the relative importance of the product utilization message to a particular user. The product utilization message and the priority data are transmitted to a user computing device for display, and the product utilization message is displayed according to the priority data. The user computing device displays both the utilization value data and the message sequencing data as part of the product utilization message.

In one embodiment, executing the transfer analysis includes the further operations of retrieving transfer instruction parameters from a Transfer Instruction Parameters database. The transfer instruction parameters can be input by the provider or a user. The transfer instruction parameters establish specified conditions to recognize when processing transfer instructions, such as source selection data specifying the name of a merchant or other third party that should be detected in the transfer instructions. For each transfer instruction received by the provider computing device, the provider computing device determines whether the terminal source identification data matches the message source selection data from the transfer instruction parameters. When a match is detected, the terminal source identification data is included in the product utilization message for display on a user computing device. In this manner, the user is alerted to the detection of a transaction with a particular third party.

In another embodiment, the provider network computing device is configured detect duplicate resource transfers. The transfer analysis includes performing the operations of passing a transfer check command to Transfer Activity database where the transfer check command includes the product identification data, the transfer value data, and the terminal source identification data. The Transfer Activity database returns a transfer database record that includes utilization value data, stored terminal source identification data, and stored product identification data. The provider computing device compares the transfer value data, terminal source identification, and product identification from the transfer instruction against the utilization value data, the stored terminal source identification data, and the stored product identification data from the transfer database record. When a match is detected, the provider computing device generates product utilization message data indicating that the transfer instruction is a duplicate transfer.

In yet another embodiment, the system is configured to detect conditions where periodic transfer instructions include transfer value data that is lower or higher than expected. The provider computing device first classifies the transaction represented by the transfer instruction. The provider computing system performs a transfer classification analysis using the transfer instructions and the transfer data. The transfer classification analysis generates transfer classification data for the transfer instruction that categorizes the transfer instruction according to the type and purpose of the transaction (e.g., a transportation cost, periodic mortgage payment, or periodic paycheck, etc.). The transfer classification data can indicate the transfer instruction is a periodic transfer.

Following the transfer classification analysis, the Transfer Monitor software service receives transfer instruction parameters that include threshold transfer value data, which is a threshold specified by a provider or a user. The Transfer Monitor software service determines whether the transfer value data for the periodic transfer instruction exceeds the threshold transfer value data. When the transfer value data exceeds the threshold transfer value data, the provider system generates product utilization message data indicating that the threshold transfer value data was exceeded.

The provider network computing device can be implemented with a neural network that is used to perform the transfer classification analysis. The neural network can be configured as a convolutional neural network having least three intermediate layers that implements a Latent Dirichlet Allocation model.

In another embodiment, the provider computing system executes a transfer predictive analysis using the transfer instruction and transfer data retrieved from the Transfer Activity database. The transfer predictive analysis generates predictive transfer data relating to expected future transfer instructions (i.e., resource transactions that may occur in the future). For potential future transfer instructions, the transfer predictive analysis can generate a terminal source identifier (i.e., the third party source or recipient of a transfer), expected transfer value data (i.e., the amount of the transfer), and expected sequencing data (i.e., a predicted time and date when the transfer will occur). The predictive transfer data is transmitted to the user computing device for display with the product utilization message.

The provider system can be configured to analyze the expected future transactions to ensure that a user account has sufficient resources to meet future demands. The provider computing device aggregates the transfer value data for each expected transfer to generate aggregate expected transfer value data. The provider computing device then accesses the Transfer Activity Database to retrieve availability data associated with the product identification data (i.e., a balance associated with a particular account or provider product). The provider computing device compares the availability data against the aggregated expected transfer value data. When the aggregated expected transfer value data exceeds the availability data, the system generates a notification indicating that available resources are insufficient to meet future demand of expected transfer instructions. The notification is transmitted to the user computing device for display as part of the product utilization message.

The provider network computing device can be implemented with a neural network that is used to perform the transfer predictive analysis. The neural network can be implemented with a network architecture selected from one of a (i) LSTM network architecture, (ii) deep-learning, recurrent neural networks, (iii) an Elman recurrent neural network, (iv) convolutional neural network, (v) multilayer perceptron network, (vi) TensorFlow network, (vii) MxNet network, (viii) PyTorch network, (ix) Keras network, or (x) Gluon network.

With regard to the priority analysis, the priority of the product utilization messages can be determined according to the sequencing data, such as prioritizing the display of newly generated product utilization messages or the display of product utilization messages that may require user action in the near future. The priority can be indicated by displaying her priority messages at a position that is closer to the top of a graphical interface than lower priority messages. In particular, the priority data can be expected sequencing data that represents a time in the future that is later than priority data for previous active product utilization messages that are currently displayed by the user computing device. The higher-priority product utilization message is displayed according to the priority data by selecting a position on a user computing device display screen to display the product utilization message that is closer to the top of the display screen relative to the previous active product utilization messages.

In yet another embodiment, the provider network computing device performs a modification analysis using transfer instruction and the transfer data. The modification analysis generates modification data that can indicate suggested changes to user transfer activity directed at optimizing a resource utilization. For example, the modification data can indicate a suggested modification to the transfer instruction utilization value (i.e., modifying the amount of a payment). The modification data is transmitted to the user computing device for display with a product utilization message.

The system includes technology for generating graphical user interfaces that enhance user access to the product utilization messages. The product utilization messages can vary in content, position, and format depending on the particular graphical interface being displayed to the user. As an example, the user computing device can display product utilization messages relating to a particular account when the user navigates to an interface to display transactions for that account. The product utilization messages are displayed as graphical widgets on a graphical interface. In some cases, the product utilization messages can be displayed as utilization message previews that include abbreviated data that facilitates efficient and expedient review of larger volumes of data by users.

First a secure communication session is established between the provider network computing device and a user computing device. The network computing device receives from the user computing device, both an interface transmit command having interface identification data (i.e., data that designates a graphical user interface (“GUI”) for display on the user computing device) and product identification data (e.g., an user account identifier). The product identification data is passed to the Transfer Activity Database, and in return, the provider network computing device receives transfer data for a plurality of resource transfers associated with the product identification data.

The provider network computing device executes a transfer analysis utilizing the transfer data. The transfer analysis generates product utilization message data that is used to generate a plurality of product utilization messages. The product utilization messages each include utilization value data and message sequencing data. The product utilization messages are filtered for display according to the interface identification data. That is, certain product utilization messages are selected for transmission to the user computing device depending on the GUI to be transmitted for display by the user computing device. The provider network computing device can optionally execute a priority analysis that processes the product utilization message to generate priority data. The selected product utilization messages and priority data are transmitted to the user computing device for display, and the selected product utilization messages are displayed according to the priority data.

In one embodiment, the product utilization message data includes product identification data, and the interface identification data designates an Account Interface GUI for display that is associated with a given product identification. The provider network computing device filters the product utilization messages for display by determining for each product utilization message, whether the product utilization message includes product identification data that matches the given product identification. When the product identification data matches the given product identification, product utilization message having matching data are transmitted to the user computing device for display. As another example, the interface identification data may designate a Homepage GUI for display. In that case, the product utilization messages are displayed by the user computing device as utilization message previews that include category descriptor data and utilization value data that provides a summary of the subject matter addressed by the product utilization message.

The network computing device can include a neural network that is used to perform the priority analysis using data that can include transfer data or information about the user computing device activities while navigating the provider system or the Internet. That is, end user computing device activities can be monitored and used to discern priority preferences to the most relevant product utilization messages are highlighted for display on the user computing device. The neural network can be a recurrent neural network having a long short-term memory neural network architecture. In another embodiment, the neural network can be a convolutional neural network having least three intermediate layers that implement a Latent Dirichlet Allocation model.

### BRIEF DESCRIPTION OF THE DRAWINGS

Features, aspects, and advantages of the present invention are better understood when the following detailed description of the invention is read with reference to the accompanying figures, in which:

FIG. 1 is an example system diagram according to one embodiment.

FIG. 2A is a diagram of a feedforward network, according to at least one embodiment, utilized in machine learning.

FIG. 2B is a diagram of a convolution neural network, according to at least one embodiment, utilized in machine learning.

FIG. 2C is a diagram of a portion of the convolution neural network of FIG. 2B, according to at least one embodiment, illustrating assigned weights at connections or neurons.

FIG. 3 is a diagram representing an example weighted sum computation in a node in an artificial neural network.

FIG. 4 is a diagram of a Recurrent Neural Network RNN, according to at least one embodiment, utilized in machine learning.

FIG. 5 is a schematic logic diagram of an artificial intelligence program including a front-end and a back-end algorithm.

FIG. 6 is a flow chart representing a method model development and deployment by machine learning.

FIG. 7 shows a first example graphical user interface displaying product utilization messages.

FIG. 8 shows a second example graphical user interface displaying product utilization messages.

FIG. 9 shows a third example graphical user interface displaying product utilization messages.

### DETAILED DESCRIPTION

The present invention will now be described more fully hereinafter with reference to the accompanying drawings in which example embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

As used herein, the terms “enterprise” or “provider” generally describes a person or business enterprise that hosts, maintains, or uses the disclosed systems and methods. The term provider generally describes the person or business enterprise providing goods or services. The term “user” is used interchangeably with the terms end user, customer, or consumer, and these terms represent individuals to whom a provider is rendering goods or services or individuals and/or with whom the provider has an ongoing relationship.

Embodiments are described with reference to flowchart illustrations or block diagrams of methods or apparatuses where each block or combinations of blocks can be implemented by computer-readable instructions (i.e., software). The term apparatus includes systems and computer program products. The referenced computer-readable software instructions may be provided to a processor of a general purpose computer, special purpose computer, or other programmable data processing apparatus to produce a particular machine. The instructions, which execute via the processor of the computer or other programmable data processing apparatus, create mechanisms for implementing the functions specified in this specification and attached figures.

The computer-readable instructions are loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the attached flowchart(s) or block diagram(s). Alternatively, computer software implemented steps or acts may be combined with operator or human implemented steps or acts in order to carry out an embodiment of the disclosed systems and methods.

The computer-readable software instructions may also be stored in a computer-readable memory that can direct a computer or other programmable data processing apparatus to function in a particular manner. In this manner, the instructions stored in the computer-readable memory produce an article of manufacture that includes the instructions, which implement the functions described and illustrated herein.

### System Level Description

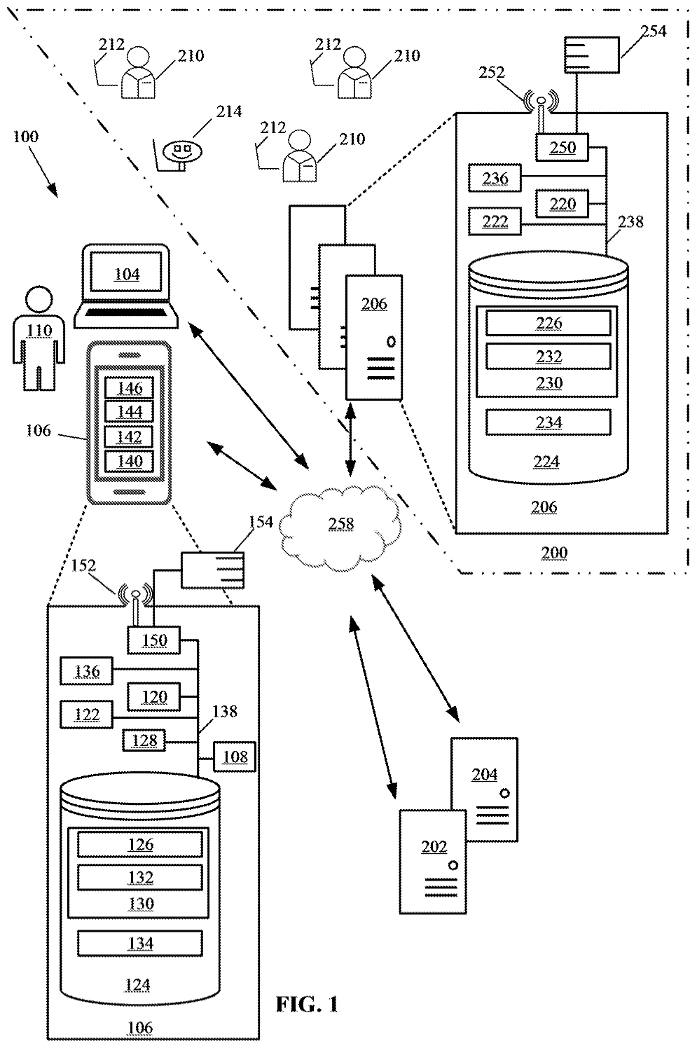

As shown in FIG. 1, a hardware system 100 configuration according to one embodiment generally includes a user 110 that benefits through use of services and products offered by a provider through an enterprise system 200. The user 110 accesses services and products by use of one or more user computing devices 104 & 106. The user computing device can be a larger device, such as a laptop or desktop computer 104, or a mobile computing device 106, such as smart phone or tablet device with processing and communication capabilities. The user computing device 104 & 106 includes integrated software applications that manage device resources, generate user interfaces, accept user inputs, and facilitate communications with other devices, among other functions. The integrated software applications can include an operating system, such as Linux®, UNIX®, Windows®, macOS®, iOS®, Android®, or other operating system compatible with personal computing devices.

The user 110 can be an individual, a group, or an entity having access to the user computing device 104 & 106. Although the user 110 is singly represented in some figures, at least in some embodiments, the user 110 is one of many, such as a market or community of users, consumers, customers, business entities, government entities, and groups of any size.

The user computing device includes subsystems and components, such as a processor 120, a memory device 122, a storage device 124, or power system 128. The memory device 122 can be transitory random access memory (“RAM”) or read-only memory (“ROM”). The storage device 124 includes at least one of a non-transitory storage medium for long-term, intermediate-term, and short-term storage of computer-readable instructions 126 for execution by the processor 120. For example, the instructions 126 can include instructions for an operating system and various integrated applications or programs 130 & 132. The storage device 124 can store various other data items 134, including, without limitation, cached data, user files, pictures, audio and/or video recordings, files downloaded or received from other devices, and other data items preferred by the user, or related to any or all of the applications or programs.

The memory device 122 and storage device 124 are operatively coupled to the processor 120 and are configures to store a plurality of integrated software applications that comprise computer-executable instructions and code executed by the processing device 120 to implement the functions of the user computing device 104 & 106 described herein. Example applications include a conventional Internet browser software application and a mobile software application created by the provider to facilitate interaction with the provider system 200.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The integrated software applications also typically provide a graphical user interface (“GUI”) on the user computing device display screen 140 that allows the user 110 to utilize and interact with the user computing device. Example GUI display screens are depicted in the attached figures. The GUI display screens may include features for displaying information and accepting inputs from users, such as text boxes, data fields, hyperlinks, pull down menus, check boxes, radio buttons, and the like. One of ordinary skill in the art will appreciate that the exemplary functions and user-interface display screens shown in the attached figures are not intended to be limiting, and an integrated software application may include other display screens and functions.

The processing device 120 performs calculations, processes instructions for execution, and manipulates information. The processing device 120 executes machine-readable instructions stored in the storage device 124 and/or memory device 122 to perform methods and functions as described or implied herein. The processing device 120 can be implemented as a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120. In other embodiments, the methods and functions described herein include cloud-based computing such that the processing device 120 facilitates local operations, such communication functions, data transfer, and user inputs and outputs.

or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

The user computing device 104 & 106 may also include a positioning device 108, such as a global positioning system device (“GPS”) that determines a location of the user computing device. In other embodiments, the positioning device 108 includes a proximity sensor or transmitter, such as an RFID tag, that can sense or be sensed by devices proximal to the user computing device 104 & 106.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

A system intraconnect 138, such as a bus system, connects various components of the mobile device 106. The user computing device 104 & 106 further includes a communication interface 150. The communication interface 150 facilitates transactions with other devices and systems to provide two-way communications and data exchanges through a wireless communication device 152 or wired connection 154. Communications may be conducted via various modes or protocols, such as through a cellular network, wireless communication protocols using IEEE 802.11 standards. Communications can also include short-range protocols, such as Bluetooth or Near-field communication protocols. Communications may also or alternatively be conducted via the connector 154 for wired connections such by USB, Ethernet, and other physically connected modes of data transfer.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 act on behalf of the provider, such as customer service representatives, advisors, managers, and sales team members.

Human agents 210 utilize agent computing devices 212 to interface with the provider system 200. The agent computing devices 212 can be, as non-limiting examples, computing devices, kiosks, terminals, smart devices such as phones, and devices and tools at customer service counters and windows at POS locations. In at least one example, the diagrammatic representation and above-description of the components of the user computing device 104 & 106 in FIG. 1 applies as well to the agent computing devices 212. As used herein, the general term “end user computing device” can be used to refer to either the agent computing device 212 or the user computing device 110 depending on whether the agent (as an employee or affiliate of the provider) or the user (as a customer or consumer) is utilizing the disclosed systems and methods to segment, parse, filter, analyze, and display content data.

Human agents 210 interact with users 110 or other agents 212 by phone, via an instant messaging software application, or by email. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components, such as a processor device 220, an input-output system 236, an intraconnect bus system 238, a communication interface 250, a wireless device 252, a hardwire connection device 254, a transitory memory device 222, and a non-transitory storage device 224 for long-term, intermediate-term, and short-term storage of computer-readable instructions 226 for execution by the processor device 220. The instructions 226 can include instructions for an operating system and various software applications or programs 230 & 232. The storage device 224 can store various other data 234, such as cached data, files for user accounts, user profiles, account balances, and transaction histories, files downloaded or received from other devices, and other data items required or related to the applications or programs 230 & 232.

The network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations.

The network 258 may be or include an enterprise or secured network, or may be implemented, at least in part, through one or more connections to the Internet. A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100.

External systems 270 and 272 represent any number and variety of data sources, users, consumers, customers, enterprises, and groups of any size. In at least one example, the external systems 270 and 272 represent remote terminal utilized by the enterprise system 200 in serving users 110. In another example, the external systems 270 and 272 represent electronic systems for processing payment transactions. The system may also utilize software applications that function using external resources 270 and 272 available through a third-party provider, such as a Software as a Service (“SasS”), Platform as a Service (“PaaS”), or Infrastructure as a Service (“IaaS”) provider running on a third-party cloud service computing device. For instance, a cloud computing device may function as a resource provider by providing remote data storage capabilities or running software applications utilized by remote devices.

SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

The embodiment shown in FIG. 1 is not intended to be limiting, and one of ordinary skill in the art will appreciate that the system and methods of the present invention may be implemented using other suitable hardware or software configurations. For example, the system may utilize only a single computing system 206 implemented by one or more physical or virtual computing devices, or a single computing device may implement one or more of the computing system 206, agent computing device 206, or user computing device 104 & 106.

### Artificial Intelligence

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (“KNN”), and the like. Additionally or alternatively, the machine learning algorithm may include one or more regression algorithms configured to output a numerical value in response to a given input. Further, the machine learning may include one or more pattern recognition algorithms—e.g., a module, subroutine or the like capable of translating text or string characters and/or a speech recognition module or subroutine. The machine learning modules may include a machine learning acceleration logic (e.g., a fixed function matrix multiplication logic) that implements the stored processes or optimizes the machine learning logic training and interface.

Machine learning technology can utilize supervised software processing techniques or unsupervised software processing techniques. Supervised software processing relies on iterative training techniques and training data to configure neural networks with an understanding of various types of data inputs. As an example, training data is utilized to train a neural network to recognize various categories of data inputs, such as labeling resource transfer data according to a purpose for which the resources were transferred.

Supervised learning software systems are trained using content data that is well-labeled or “tagged.” During training, the supervised software systems learn the best mapping function between a known data input and expected known output (i.e., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a calculated probability and a desired threshold probability.

The software systems are supervised because the way of learning from training data mimics the same process of a teacher supervising the end-to-end learning process. Supervised learning software systems are typically capable of achieving excellent levels of performance but only when enough labeled data is available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of data that the system will process in a production environment. Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”).

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-mean clustering, Mean-Shift clustering, Density-based clustering, Spectral clustering, Principal Component Analysis, and Neural Topic Modeling (“NTM”).

Clustering software techniques can automatically group similar data together to accelerate the derivation and verification a new classification or subject, and not just classification into an existing subject or classification. Unsupervised learning software systems are also used for association rules mining to discover relationships between features from content data. Unsupervised learning software systems can be less accurate than well-trained supervised systems, but such software systems have the advantage of avoiding the need for large, carefully labeled sets of training data that are processed by expert personnel.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (e.g., DBSCAN), mean shift clustering, expectation maximization (e.g., EM) clustering using Gaussian mixture models (e.g., GMM), agglomerative hierarchical clustering, or the like. In one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

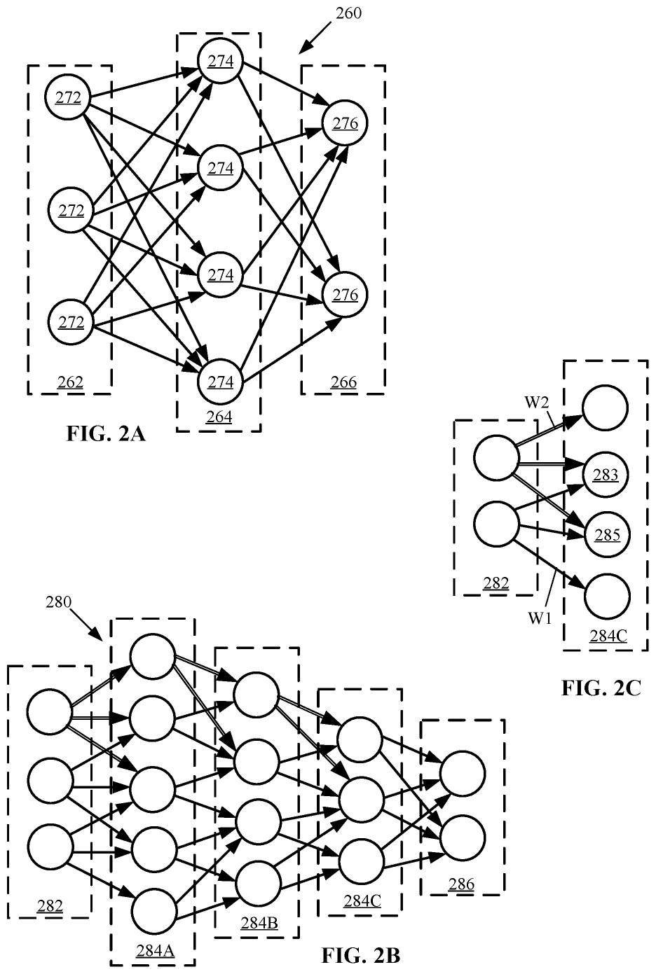

A feedforward network 260 (as depicted in FIG. 2A) may include a topography with a hidden layer 264 between an input layer 262 and an output layer 266. The input layer 262 includes input nodes 272 that communicate input data, variables, matrices, or the like to the hidden layer 264 that is implemented with hidden layer nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge.

In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers. That is, the hidden layer 264 implements activation functions between the input data communicated from the input layer 262 and the output data communicated to the nodes 276 of the output layer 266.

It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem.

Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient (e.g., a propagated value). The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An additional or alternative type of neural network suitable for use in the machine learning program and/or module is a Convolutional Neural Network (“CNN”). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program.

A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An example convolutional neural network CNN is depicted and referenced as 280 in FIG. 2B. As in the basic feedforward network 260 of FIG. 2A, the illustrated example of FIG. 2B has an input layer 282 and an output layer 286. However where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

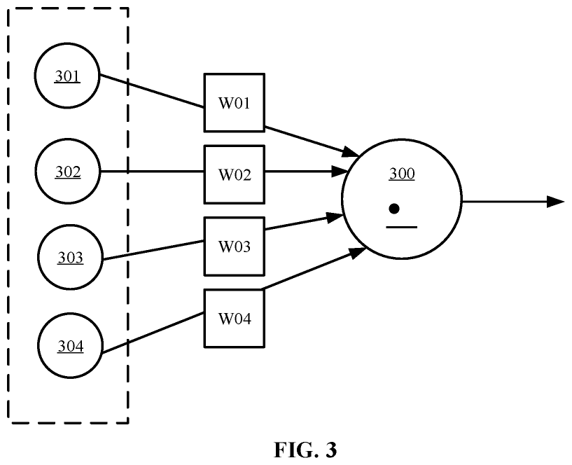

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent Neural Network (“RNN”). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter. That is, at least a portion of the output data from the RNN may be used as feedback or input in calculating subsequent output data. In some embodiments, the machine learning module may include an RNN configured for language processing (e.g., an RNN configured to perform statistical language modeling to predict the next word in a string based on the previous words). The RNN(s) of the machine learning program may include a feedback system suitable to provide the connection(s) between subsequent and previous layers of the network.

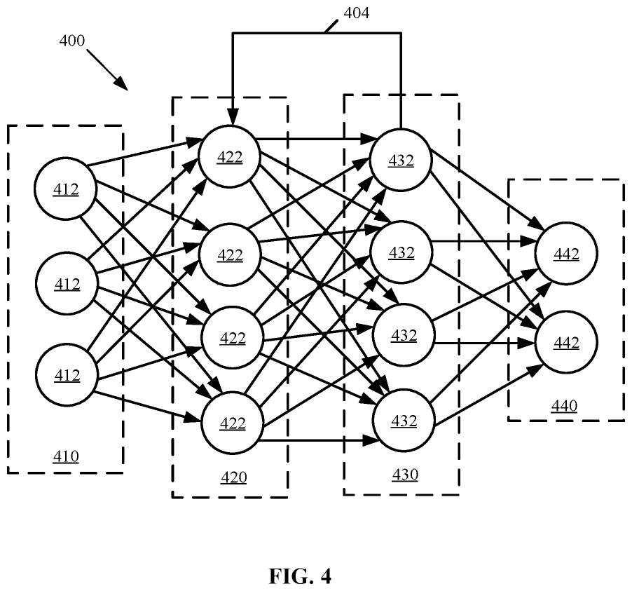

An example RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more nodes of a subsequent layer may provide or communicate a parameter or other data to a previous layer of the RNN network 400. Moreover, in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them (i.e., nodes of nonsequential layers of the RNN 400).

In an additional or alternative embodiment, the machine learning program may include one or more support vector machines. A support vector machine may be configured to determine a category to which input data belongs. For example, the machine learning program may be configured to define a margin using a combination of two or more of the input variables and/or data points as support vectors to maximize the determined margin. Such a margin may generally correspond to a distance between the closest vectors that are classified differently. The machine learning program may be configured to utilize a plurality of support vector machines to perform a single classification. For example, the machine learning program may determine the category to which input data belongs using a first support vector determined from first and second data points/variables, and the machine learning program may independently categorize the input data using a second support vector determined from third and fourth data points/variables. The support vector machine(s) may be trained similarly to the training of neural networks (e.g., by providing a known input vector, including values for the input variables) and a known output classification. The support vector machine is trained by selecting the support vectors and/or a portion of the input vectors that maximize the determined margin.

As depicted, and in some embodiments, the machine learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers).

Generally, the neural network(s) of the machine learning program may include a relatively large number of layers (e.g., three or more layers) and are referred to as deep neural networks. For example, the node of each hidden layer of a neural network may be associated with an activation function utilized by the machine learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

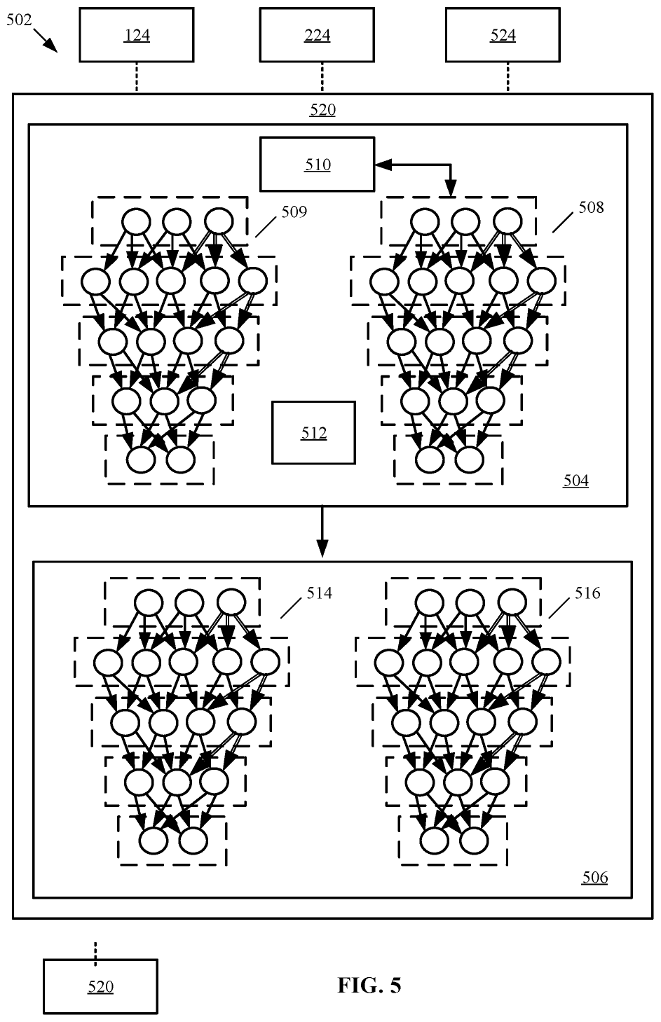

Referring now to FIG. 5 and some embodiments, an artificial intelligence program 502 may include a front-end algorithm 504 and a back-end algorithm 506. The artificial intelligence program 502 may be implemented on an AI processor 520. The instructions associated with the front-end algorithm 504 and the back-end algorithm 506 may be stored in an associated memory device and/or storage device of the system (e.g., storage device 124, memory device 122, storage device 124, and/or memory device 222) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end network 506 configured to perform an operation on the data set communicated directly or indirectly to the back-end network 506). For instance, the front-end program 506 can include at least one CNN 508 communicatively coupled to send output data to the back-end network 506.

Additionally or alternatively, the front-end program 504 can include one or more AI algorithms 510, 512 (e.g., statistical models or machine learning programs such as decision tree learning, associate rule learning, recurrent artificial neural networks, support vector machines, and the like). In various embodiments, the front-end program 504 may be configured to include built in training and inference logic or suitable software to train the neural network prior to use (e.g., machine learning logic including, but not limited to, image recognition, mapping and localization, autonomous navigation, speech synthesis, document imaging, or language translation, such as natural language processing). For example, a CNN 508 and/or AI algorithm 510 may be used for image recognition, input categorization, and/or support vector training.

In some embodiments and within the front-end program 504, an output from an AI algorithm 510 may be communicated to a CNN 508 or 509, which processes the data before communicating an output from the CNN 508, 509 and/or the front-end program 504 to the back-end program 506. In various embodiments, the back-end network 506 may be configured to implement input and/or model classification, speech recognition, translation, and the like. For instance, the back-end network 506 may include one or more CNNs (e.g, CNN 514) or dense networks (e.g., dense networks 516), as described herein.

For instance and in some embodiments of the AI program 502, the program may be configured to perform unsupervised learning, in which the machine learning program performs the training process using unlabeled data (e.g., without known output data with which to compare). During such unsupervised learning, the neural network may be configured to generate groupings of the input data and/or determine how individual input data points are related to the complete input data set (e.g., via the front-end program 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known (e.g., a mix of labeled and unlabeled data having the same distribution).

In some embodiments, the AI program 502 may be accelerated via a machine learning framework 520 (e.g., hardware). The machine learning framework may include an index of basic operations, subroutines, and the like (primitives) typically implemented by AI and/or machine learning algorithms. Thus, the AI program 502 may be configured to utilize the primitives of the framework 520 to perform some or all of the calculations required by the AI program 502. Primitives suitable for inclusion in the machine learning framework 520 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine learning program may include variations, adaptations, and alternatives suitable to perform the operations necessary for the system, and the present disclosure is equally applicable to such suitably configured machine learning and/or artificial intelligence programs, modules, etc. For instance, the machine learning program may include one or more long short-term memory RNNs, convolutional deep belief networks, deep belief networks DBNs, and the like. DBNs, for instance, may be utilized to pre-train the weighted characteristics and/or parameters using an unsupervised learning process. Further, the machine learning module may include one or more other machine learning tools (e.g., Logistic Regression (“LR”), Naive-Bayes, Random Forest (“RF”), matrix factorization, and support vector machines) in addition to, or as an alternative to, one or more neural networks, as described herein.

Those of skill in the art will also appreciate that other types of neural networks may be used to implement the systems and methods disclosed herein, including, without limitation, radial basis networks, deep feed forward networks, gated recurrent unit networks, auto encoder networks, variational auto encoder networks, Markov chain networks, Hopefield Networks, Boltzman machine networks, deep belief networks, deep convolutional networks, deconvolutional networks, deep convolutional inverse graphics networks, generative adversarial networks, liquid state machines, extreme learning machines, echo state networks, deep residual networks, Kohonen networks, and neural turning machine networks, as well as other types of neural networks known to those of skill in the art.

Different neural network architectures can be more particularly suited for particular uses to process different types of data inputs and render specific outputs. For example, different neural network architectures can be better suited to perform natural language processing and topic modeling while other types of neural network architectures are more well suited for predictive modeling of future expected data.

To implement natural language processing technology, for example, suitable neural network architectures can include, without limitation: (i) multilayer perceptron (“MLP”) networks having three or more layers and that utilizes a nonlinear activation function (mainly hyperbolic tangent or logistic function) that allows the network to classify data that is not linearly separable; (ii) convolutional neural networks; (iii) recursive neural networks; (iv) recurrent neural networks; (v) LSTM network architecture; (vi) Bidirectional Long Short-Term Memory network architecture, which is an improvement upon LSTM by analyzing word, or communication element, sequences in forward and backward directions; (vii) Sequence-to-Sequence networks; and (viii) shallow neural networks such as word2vec (i.e., a group of shallow two-layer models used for producing word embedding that takes a large corpus of alphanumeric content data as input to produces a vector space where every word or communication element in the content data corpus obtains the corresponding vector in the space).

To perform predictive analysis of expected future values of data, suitable neural network architectures can include various deep-learning techniques and specific architectures that include, but are not limited to: (i) LSTM network architecture; (ii) deep-learning, cyclic recurrent neural networks; (iii) an Elman recurrent neural network; (iv) convolutional neural networks; (v) multilayer perceptron networks; (vi) TensorFlow networks; (vii) MxNet networks; (viii) PyTorch networks; (ix) Keras networks; and (x) Gluon networks.

With respect to clustering software processing techniques that implement unsupervised learning, suitable neural network architectures can include, but are not limited to: (i) Hopefield Networks; (ii) a Boltzmann Machines; (iii) a Sigmoid Belief Net; (iv) Deep Belief Networks; (v) a Helmholtz Machine; (vi) a Kohonen Network where each neuron of an output layer holds a vector with a dimensionality equal to the number of neurons in the input layer, and in turn, the number of neurons in the input layer is equal to the dimensionality of data points given to the network; (vii) a Self-Organizing Map (“SOM”) having a set of neurons connected to form a topological grid (usually rectangular) that, when presented with a pattern, the neuron with closest weight vector is considered to be the output with the neuron's weight adapted to the pattern, as well as the weights of neighboring neurons, to naturally find data clusters; and (viii) a Centroid Neural Network that is premised on Kmeans clustering software processing techniques.

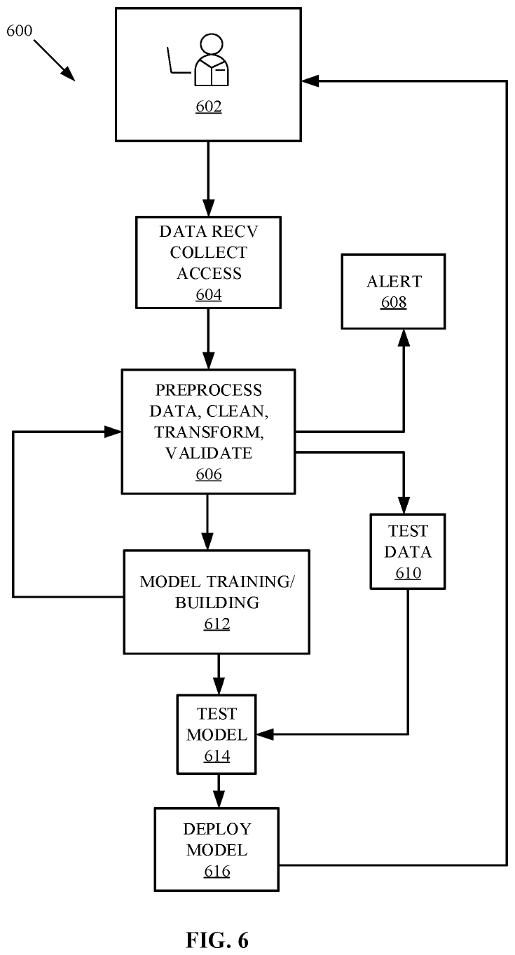

Turning to FIG. 6, a flow chart representing a method 600, according to at least one embodiment, of model development and deployment by machine learning. The method 600 represents at least one example of a machine learning workflow in which steps are implemented in a machine learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop.

In step 604, user evaluation data is received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated.

Step 606 can include data validation to confirm that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning work flow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

### Establishing a Communication Session for Transmission of a Transfer Instruction

Transfer instruction parameters are applied to evaluate individual transactions by a Transfer Monitor software service. Transfer instructions can be initiated by a user or received from a third party, such as an employer or customer making a resource transfer (i.e., a payment) to a user. Users can initiate a transfer instruction at a remote location with a user computing device, such as a smart phone or smart card device that has an integrated processor, memory, and software applications.

Users commonly initiate transfer instructions at a remote location such as a point of sale device in a brick-and-mortar retail location. However, transfer instructions can be initiated from a variety of locations where Internet access is available, such as when a user is operating a personal computing device at home or work to make online purchases or to initiate electronic transfers to or from a user account.

Resource transfer instructions initiated by a user are transmitted to a terminal computing device operated by a third party, such as a retailer or service provider. The terminal computing device can be, for example, a mobile computing device such as a tablet computer or a point-of-sale device at a retail location. In other embodiments, the terminal computing device can be a network device, such as a server, that processes incoming transfer instructions generated by user computing devices that are initiating transactions over the Internet. In other instances, the transfer instruction is initiated by the third-party to implement the transfer resource to a user account administered by the provider.

The terminal computing device generates terminal data that is presented to a user on a display screen. Terminal data can include transfer value data, which represents the quantity or amount of resources that are transferred during a transaction, as well as terminal product identifier data that represents products or services subject to a transfer instruction. The user computing device initiates a transfer instruction by first providing data that verifies the identity of the user and/or the user computing device. Once verified, the user computing device transmits additional data and information relevant to the transfer instruction, such as a product identification or production identification and provider identifier data.

User and user device identity can be authenticated using techniques, such as verifying authentication data (e.g., a password) or verifying system configuration data. In some embodiments, users and devices are verified using authentication data such as a personal identification number (“PIN”) or card verification value (“CVV”), received from a user and comparing the received authentication data to known values stored to a database on the provider system. In other embodiments, when a user generates a transfer instruction using a smart card, smartphone, or other device with a secure chip, authentication can be accomplished through symmetric or asymmetric key encryption for authentication. Encryption methods can include, for instance, symmetric Data Encryption Standard (“DES”), 3DES, and public key Rivest-Shamir-Adleman's algorithm (“RSA”).

Asymmetric key encryption uses a private encryption key that must be kept secret from unauthorized users and a public encryption key that can be made available through unsecure channels. The public and private keys are mathematically linked. Transmitted data that is encrypted with the public key can be unencrypted only with the private key, and data encrypted with the private key can be verified only with the public key. Suitable asymmetric key encryption algorithms include, but are not limited to, the RSA algorithm, elliptic curve cryptography, Internet Key Exchange protocols, and PGP encryption protocols, among others.

In a particular communication session between two devices, each device utilizes its own public-private encryption key pair. The encryption key pairs can be exchanged between devices during the initiation of a communication session or during an authentication and enrollment process. Alternatively, the encryption key pairs can be preinstalled on the computing devices prior to being placed into production. In other words, prior to being used to implement the systems and methods of the present invention, the provider system can be loaded with both its own public-private encryption key pair and the public-private key pair of a user computing device or smart device.

During a communication session, the user smart device or user computing device can create a random number that is encrypted using a private key. The encrypted information is transmitted to a third party computing device that decrypts the information utilizing the public key to verify that the user device signed the communication. Conversely, communications transmitted back to the user device can be encrypted by the third party computing device using the public key and decrypted by the user device using the private key to verify the authenticity of the communication.

The user computing device, which may be a smart card or mobile computing device, and the terminal computing device can each include a built-in encrypted digital certificate. The digital certificate is issued by a trusted certificate authority that verifies the security and authenticity of a provider. The certificate authority is a registration authority that acts as a verifier for the certification authority before certificates including information of public keys or private keys and digital certifications are issued to requesters, one or more directories where the certificates with their public keys are held, and a certification management system that manages the certificates.

In public key cryptography, public and private keys are simultaneously created using the same algorithm by a certification authority. The private key is given only to requesters, and the public key is disclosed in directories, which all users can access, as parts of digital certificates. The private key is not shared with another user or is not transmitted across the Internet. Users employ a private key to decrypt a text that has been encrypted with the user's public key by another party that can obtain the user's public key from a public directory. Thus, a party transmitting a message obtains the public key of a user (i.e., the receiving party) through a central administrator, and the transmitter encrypts the message with the public key before transmitting the message to the receiving party. The receiving party decrypts the message using the receiving party's private key. In addition to encrypting the message, the transmitter can authenticate the user by using the user's private key to encrypt a digital certificate.

The digital certificate is encrypted using a private key and transmitted from one device to another as part of commencing a communication session. The digital certificate is decrypted using the public key of the receiving device, and the resulting decrypted data is compared against known values to authenticate the certificate holder.

Once a device is authenticated using a digital certificate, a communication session between two devices can be established, such as between a user computing device and a terminal computing device. During a communication session, a transmitting device encrypts or encodes a communication with a private key prior to transmitting a message. Upon receipt of a communication from a transmitting computing device, the receiving computing device uses a corresponding public key to unencrypt the communication.

Those of skill in the art will appreciate that the above examples are not intended to be limiting, and other suitable techniques can be used to authenticate and secure transfer instructions. For instance, rather than a random number, a user smart card or user computing device can transmit encrypted system configuration data verified by a provider computing system.

In some embodiments, user device information can be encrypted using one-way hashing techniques that apply a hashing algorithm to known data to create a one-way hash value. Any suitable hashing algorithm can be used, including, but not limited to, SHA-1 or SHA-2 algorithms. A one-way hash value is preferably a value of fixed length that is unique to the known data. In other words, if the known data is changed in any respect, the hash value will also change. The hash value, thus, acts as a fingerprint for the known data. The smart device, user computing device, terminal computing device, or a provider computing system can also optionally apply a digital “signature” or certificate authority to data included in the various communication. The digital signature or certificate authority further authenticates the source of a communication and can be accomplished using any suitable technique known to one of ordinary skill in the art.

### Authenticating to a Provider System and Capturing System Configuration Data

Users interact with a provider and access the provider network through a user computing device running one or more integrated software applications that generate a Graphical User Interface (“GUI”) rendered on a display. The software applications can include, for example, an Internet browser software application or a dedicated software application such as a “mobile app.” The user computing device interacts with components of a provider system, such as various network computing devices (i.e., a server).

In particular, user computing devices communicate with a provider system by sending data to and from external, public-facing component of the provider computing system, such as an external server that can be a web server or other external communication computing device. The external server in turn interacts with an internal interface computing device also associated with a provider computing system. Among other functions, the internal interface computing device is responsible for processing sensitive data gathered from the “back end” components of a provider computer system that may be protected by a firewall software application or system. The internal interface computing devices thus prevent third-party computing devices and applications and from having direct access to the sensitive data stored to a provider system.

The provider external server processes communication data requests sent to, and received from, the user computing device or from third party applications and computing devices. The external server routes communications requesting sensitive data through the internal server for secure communication. The internal server in turn communicates with other back end components of the provider system, such as databases and servers that store sensitive user data (e.g., account numbers, addresses, resource availability data, etc.).

In accessing the provider system, the user computing device transmits a user interface transmit command to the external server that can include: (i) an Internet Protocol (“IP”) address for the user computing device; (ii) system configuration data; and (iii) navigation data (e.g., data corresponding to browsing history, or websites and Internet Protocol addresses accessed by the user computing device). In response to the user interface transmit command, the external server returns interface display data and a digital cookie that is stored to the user computing device and used to track functions and activities performed by the user computing device.

In some embodiments, the system configuration data and navigation data is utilized by the external server to generate the interface display data. For instance, the system configuration data might indicate that the user computing device is utilizing a particular Internet browser or mobile software application to communicate with the provider system. The external server then generates interface display data that includes instructions compatible with, and readable by, the particular Internet browser or mobile software application. As another example, if the navigation data indicate the user computing device previously visited a provider webpage, the interface display data can include instructions for displaying a customized message on the user computing device, such as “Welcome back Patrick!”

After receiving interface display data, the user computing device processes the display data and renders GUI screens presented to users, such as a provider website or a GUI within a provider mobile software application. In some embodiments, the system configuration data may be sent to the provider system in a separate message subsequent to the user interface transmit command message.

The interface display data can include one or more of the following: (i) webpage data used by the user computing device to render a webpage in an Internet browser software application; (ii) mobile app display data used by the user computing device to render GUI screens within a mobile software application; (iii) product utilization message content data that includes alphanumeric data and graphical elements used to display resource notifications on the user computing device; (iv) user transfer data, or just “transfer data,” that is used by the user computing device to render a webpage GUI that provides users access to view user resource availability data (e.g., account types and balances) and to view, select, and establish transfer instruction parameters. Categories of interface display data can include graphical elements, digital images, text, numbers, colors, fonts, or layout data representing the orientation and arrangement graphical elements and alphanumeric data on a user interface screen.

The user computing device may also transmit system configuration data to the provider system that is used to verify a user identify or authenticate the user computing device. System configuration data can include, without limitation: (i) a unique identifier for the user computing device (e.g., a media access control (“MAC”) address hardcoded into a communication subsystem of the user agent computing device); (ii) a MAC address for the local network of a user computing device (e.g., a router MAC address); (iii) copies of key system files that are unlikely to change between instances when a user accesses the provider system; (iv) a list of applications running or installed on the user computing device; and (v) any other data useful for evaluating users and authenticating a user or user computing device.

The provider system can determine location data for the user computing device based on the user device IP address. The provider system includes a software application that transmits the user device IP address to an Identity & Location API that utilizes the device IP address to determine an approximate geographic location of the user computing device. The Identity & Location API passes the user device IP address to a database or a third-party software service that returns geographic location data for the user device IP address, such as a city, county, or state. The Identity & Location API stores the geographic data to a database record on the provider system in an End User Database, as discussed in more detail below.

The user computing device authenticates to the provider system if the user has an existing electronic account with the provider. The user computing device navigates to a login GUI and enters user authentication data, such as a user name and password. The user then selects a submit function on the login GUI to transmit an user authentication request message that includes the user authentication data to the provider external server. In some embodiments, the user authentication data and user authentication request message can further include elements of the system configuration data that are used to authenticate the user, such as a user computing device identification or a user device IP address.

The external server passes user authentication request message to an identity management service, which performs a verification analysis to verify the identity of the user or user computing device. The verification analysis compares the received user authentication data to stored user authentication data to determine whether the received and stored authentication data sets match. The identity management service, thus, determines whether a correct user name, password, or device identification, or other authentication data is received. The identity management service returns an authentication notification message to the external server. The authentication notification message includes a verification flag indicating whether the verification passed or failed and a reason for a failed authentication, such as an unrecognized user name, password, or user computing device identification.

The user authentication request message can also include system configuration data, and the provider's back end servers can use system configuration data and user account data to perform the authentication process. As one example, the identity management service might store a user computing device MAC address to a database record as part of the user account data. Upon receipt of an user authentication request message that includes a MAC address, the identity management service compares the received MAC address data against stored MAC address data that is associated with the user account data. In this manner, the user computing device can also be authenticated to the provider system. If the received and stored MAC addresses do not match, the identity management service returns an authentication decision message to the external server indicating the authentication failed because the user computing device could not be authenticated. The external server can then prompt the user to verifying whether the consumer is using a new device to login to the provider system, and if so, being the process of registering a new device to the provider's system.

The system can also utilize multifactor authentication techniques (“MFA”) to authenticate the user identity or a user computing device. As one example, if the user authentication data is successfully verified, a MFA software process running on the provider system can initiate a telephone call to a phone number stored as part of the verification analysis. Upon receiving the call, the user selects an input function on the telephone to transmit response data to the MFA software process that confirms receipt of the call, thereby further authenticating the user's identity. The function can be the user's selection of any key on the telephone or a pre-determined sequence of keys, such as a passcode.

Those of skill in the art will appreciate that other forms of MFA are possible, such as sending a text message containing a passcode to the user's cellular phone that must be entered into a user interface screen or utilizing a separate software application running on the user computing device to generate a key or passcode that is verified by the provider system.

### Interfacing with a Provider System

After authenticating a user identity and/or a user computing device, the user computing device can process received interface display data to display one or more Resource Management GUIs. Users navigate a provider's system using the Resource Management GUIs that display, without limitation, end user data, product utilization messages, and transfer data stored to a Transfer Activity Database. Users can perform a variety of functions, including, without limitation, manage a user account, establish account settings, review transfer data, initiate resource transfers between accounts, or initiate resource transfer transactions with third parties. The Resource Management GUIs also display product utilization messages that can vary in substance and format from one interface to the next, as discussed in more detail below.

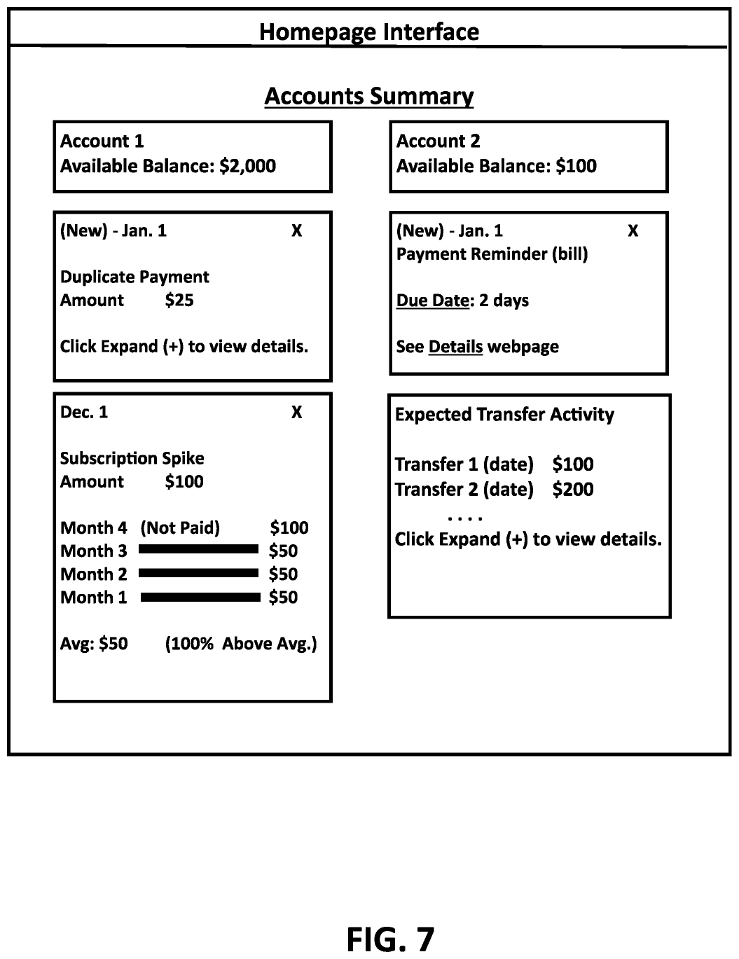

Upon authenticating to the provider system, user computing devices can receive interface display data for rendering a Homepage GUI on the user computing device, such as the example Homepage GUI shown in FIG. 7. The Homepage GUI displays information relating to user accounts and products, including, without limitation: (i) a provider product identification (e.g., an account name, number, or nickname such as “Patrick's Checking” or “Boat Loan”); (ii) resource availability data for each user account or product (e.g., balances for various product types or account types associated with or held by a user); and (iii) one or more utilization message previews that can be expanded to display full product utilization messages (see FIG. 7). The Homepage can further include navigation input functions that allow users to navigate and display additional Resource Management GUIs, such as an Account Interface that displays transfer data for each account or product held by a user; (ii) a Transfer Instruction Parameters GUI that provides an interface where users can establish or modify transfer instruction parameters; and (iii) a User Profile GUI where users can access and edit end user data stored to an End User Database.

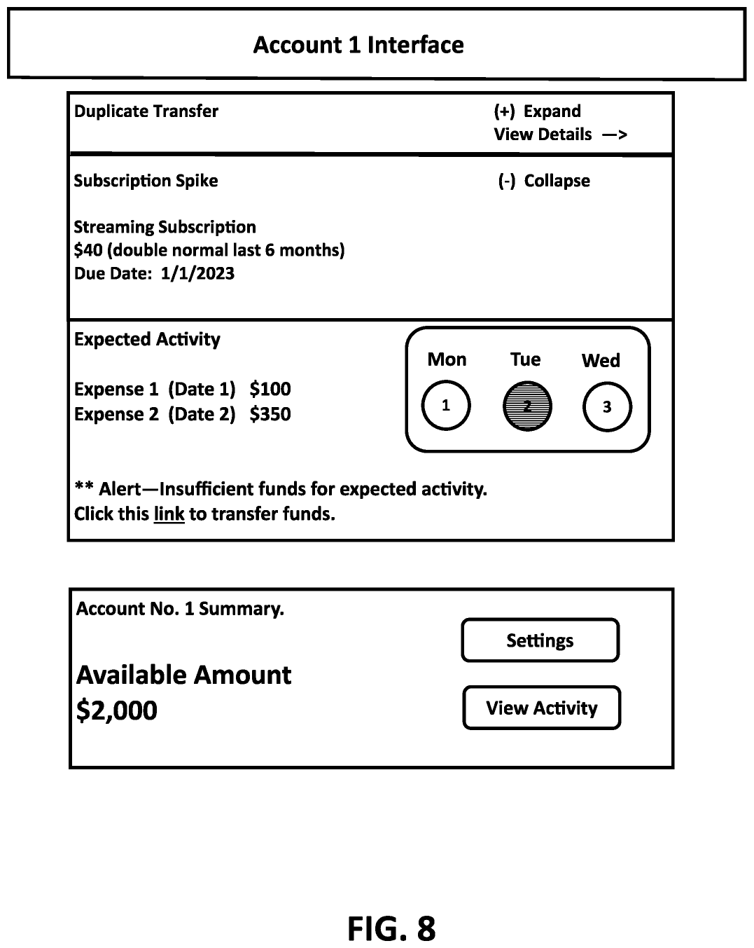

An example Account Interface GUI is shown in FIG. 8 and configured to display user transfer data. The user transfer data is stored to a Transfer Activity Database on the provider system as a series of individual transfer database records. The transfer database records correspond to individual transactions performed by a user over time where each transaction involves the transfer of resources. The Transfer Activity Database can include data relating to one or more accounts held by a user, such as checking or credit card accounts.

The Transfer Activity Database is implemented as a relational database that stores the resource transfer data in manner that allows various types of data elements to be associated with, or correspond to, one another when stored to a database record. The transfer database records store information that includes, without limitation: (i) the unique user identifier that designates a provider user that owns or has custody and control over a particular account or product; (ii) an account identification; (iii) resource availability data for each user account or product (e.g., balances for various product types or account types associated with, or held by, a user); (iv) utilization value data representing the value of resources utilized during transaction; (v) transfer event sequencing data (e.g., a date and time that a given transaction occurred or that otherwise indicates when one transaction occurred relative to another); (vi) a transaction identifier that identifies or characterizes a transaction during which resources were utilized; (vii) a terminal source identification, which can be a name or identification number (e.g., an employment identification number) of another party to a payment transaction, such as a retailer that accepts payment from a user, or an individual or employer that makes a payment to a user; (viii) transaction location data that indicates where a given transaction occurred (e.g., a zip code, city, or state); (ix) transfer classification data, such as an alphanumeric code, word, or phrase that categorizes a resource transfer or transaction and that can relate to the purpose for which resources are transferred (e.g., transportation expense, housing, groceries, or a paycheck from an employer, or an alphanumeric code representing such a category, such as a Merchant Category Code); (x) average resource availability data that indicates the average value of products or account balances maintained by the user over a given time period (e.g., an average monthly balance for an account held by the user); and (xi) average resource transfer volume data indicating the average number of transactions a user conducts using a given product or account over a given time period (e.g., the number of transfer instructions per month for a given account).

Through the provider system, users can also navigate to display a User Profile GUI that displays a variety of end user data. The end user data is stored to an End User Database as user profile database records and includes, without limitation: (i) a unique user identifier; (ii) user contact data, such as a mailing address or a geographic region where the user resides (e.g., a zip code, city, state); (iii) user source data, such as user telephone number data, user device IP address, an email address, or a social media account name; (iv) user demographic data, including the gender and age of a user; (v) one or more account identifications or provider product identifiers that indicate the accounts or products currently held by a user; (vi) location data, such as a geographic position as determined from a Global Positioning System (“GPS”) integrated with the user computing device or from a user computing device IP address; (vii) user activity data that is representative of various functions or selections utilized by a user; (viii) system configuration data; and (ix) navigation data.

The user activity data can include a wide variety of information that tracks activities of a user when utilizing a provider system. Examples of user activity data include, but are not limited to: (i) a log of user attempts to access a provider system, including the date, time, device used, and device IP address; (ii) navigation data, including the GUIs accessed by a user while logged into the provider system; (iii) settings edited by a user or selections made by a user (e.g., a selection to view or decline to view a notification or message); (iv) a log of written communications between a user and a provider, including the communication content data, a date, time, an identifier for the device used, and a device IP address; (v) a log of support requests or telephone calls between a user and a provider; (vi) resource transfers logs; or (vii) other functions and activities performed by a user that are capable of being recorded electronically.

User computing devices can also access and display a Transfer Instruction Parameters GUI that provides an interface where users can establish or modify transfer instruction parameters. Once input into the Transfer Instruction Parameters GUI and saved, the transfer instruction parameters are stored to a Transfer Instructions Parameters database on the provider system. When stored to the Transfer Instructions Parameters relational database, the transfer instruction parameters are stored as database records that include, without limitation, an unique user identifier, a user account identification, or a provider product identifier. Storing the transfer instruction parameters with such data allows the transfer instruction parameters to be associated with, or correspond to, data that identifies specific users and user accounts and products to which the transfer instruction parameters should be applied.

The transfer instruction parameters are used by a Transfer Monitor software service to process transfer instructions. Transfer instruction parameters allow the provider or individual users to set customized rules that determine the actions taken or the messages generated and displayed to a user after processing transfer instructions. The provider or users can select or de-select various categories of product utilization messages to receive or set thresholds that determine when the product utilization messages are generated and/or displayed to a user. The transfer instruction parameters can also be used to set the priority of product utilization messages displayed to a user. For instance, a provider or user can prioritize the display of messages indicative of a potential duplicate transfer instruction over lower priority messages indicative of expected future transfer instructions.

To illustrate, a provider or user can establish threshold instruction parameters that cause the provider system to generate a product utilization message, alert, or notification, when a transfer instruction is received or processed from a particular source, such as a purchase or refund from a particular merchant, a payment from employer or customer, or a payment instruction for a payment owed to a utility provider. As another example, transfer instruction parameters can be established that cause the provider system to display a product utilization message when the system detects a transfer instruction having transfer value data over a specified threshold, such as any payments received or sent over $1,000. As a further example, a provider or user could set transfer instruction parameters whereby the provider or user elects to display, or not to display, certain categories or types of product utilization messages, such as displaying messages relating to expected transfer instruction activity (e.g., an anticipated monthly subscription charge) but electing not to display messages relating to recommended modifications to future transfer instructions (e.g., a recommendation to pay additional amounts on a loan to reduce interest owed on the loan). User elections can be made by selecting available input functions, such as radio buttons or checkboxes, on the Transfer instruction Parameters GUI.

In other embodiments, providers or users could enter transfer instruction parameters that determine when, how, and how many product utilization messages are received. For instance, a provider or user could specify that product utilization messages should only be displayed on the Homepage GUI but not an Account Interface GUI. Or a provider or user could specify that the five most recent product utilization messages should be displayed on the Homepage GUI, but all available product utilization messages should be displayed on the Account Interface GUI.

Example transfer instruction parameters include: (i) message category selection data corresponding to the types or categories of product utilization messages to receive or not receive; (ii) threshold transfer value data, which can be); (iii) source selection data that is used to generate a product utilization message when a transfer instruction is received from a specified source; (iv) message volume selection that specifies the number of product utilization messages to display on a given interface); (v) message priority data specifying that certain product utilization messages are displayed with a higher priority than others, where priority can be indicated by positioning of the message on an interface, font size, color-coding, or other priority indicator techniques; (vi) message interface placement selection data that specifies the GUIs that display a product utilization message.

While authenticated to a provider system, users are presented with one or more graphical widgets that display product utilization messages. The product utilization messages are comprised of product utilization message data. The product utilization messages present users with contextual and analytical insights concerning resource transfers, and the messages are derived from data stored to the Transfer Activity Database, End User Database, and Transfer Instruction Parameter database, and received as transfer instructions, among other sources. The product utilization messages can be displayed as a resource message preview that includes: (i) category descriptor data, which is a word or short phrase that characterizes the message; and (ii) truncated message content data (i.e., alphanumeric text that can be a subset of the message content data, such as the first line or specific number of words from the content data).

Example product utilization messages are shown in FIGS. 7-9. The product utilization messages can display product utilization data that includes, but is not limited to: (i) message sequencing data, such as the time and date a transfer instruction was processed or a future time and date when a remote transfer instruction is expected to occur; (ii) utilization value data that quantifies the amount of resources subject to the product utilization message; (iii) polarity data that indicates a positive or negative value for the utilization value data and whether the resources are being transmitted from, or received by, a user or provider account; (iv) a transaction identifier that designates an unique transaction that is the subject of the product utilization message; (v) terminal source identification data that designates the source of a transfer instruction (e.g., a merchant, employer, etc.); (vi) category descriptor data; (vii) message content data; (viii) transfer classification data that characterizes the resources transferred in a transaction and can describe the intended purpose of the transfer.

### Transfer Analysis

An example process for analyzing resource transfers and generating product utilization messages is described as follows. A terminal computing device presents relevant terminal data to a user through a display screen on the terminal computing device or the user computing device. Relevant terminal data includes, for example, the transfer value data. The user then initiates a communication session by first verifying the user and/or user computing device through entering or transmitting authentication data, a certificate authority, or other relevant authentication data described above.

Once a communication session is established, the user computing device or the terminal computing device generates the transfer instruction as a packet or message that includes various elements of data. The transfer instruction is transmitted to the provider system and processed by a Transfer Monitor software service, or another software application integrated with, or running on, a provider computer system. In other embodiments, the Transfer Monitor software service can be implemented as a remote SaaS application installed on a remote physical or virtual computing device. In any case, communications between the user computing device and the terminal computing device, and communications with the provider system, can all be encrypted using symmetric or asymmetric encryption techniques. Communications are encoded or encrypted using a private key prior to transmission and then decoded or unencrypted using a public key by the receiving computing device.

The transfer instruction transmitted to the provider computing system includes, without limitation, information such as: (i) transfer value data (i.e., an amount or value of resources requested for utilization); (ii) transfer instruction sequencing data (e.g., a date and time for the transfer instruction or that otherwise indicates an order in which the transfer instruction was received relative to other instructions); (iii) a product identification; (iv) an unique user identifier; (v) provider identifier data; (vi) provider routing data used to route the remote transfer instruction to the provider system; and (vii) terminal source identification data. The transfer instructions can further include data from the terminal computing device, including, but not limited to: (viii) terminal device identification data; (ix) terminal source identification data; (x) transfer classification data; (xi) terminal location data; (xii) terminal product identifier data, which represents an identifier for products or services that are purchased or sold as part of a transaction between a user and a third party (e.g., a retailer or customer), and is distinguishable from provider product identifier, which designates a product or service offered by a provider and held by a user as a customer of the provider; and (xiii) any other data and information useful for characterizing a resource transfer.

In some embodiments, the terminal computing device generates terminal data that is sent to the provider computing system. The terminal data can be included as part of the transfer instruction or sent as a separate transmission to the provider system. The terminal data can include data and information that relates to a given transaction, identifies the terminal computing device, and/or that characterizes the third party that owns or administers the terminal computing device. The terminal data can include, without limitation: (i) terminal device identification data; (ii) terminal source identification data that identifies the third party that administers or owns the terminal computing device; (iii) terminal transfer classification data (e.g., an alphanumeric code, name, or other data, like a Merchant Category Code, that corresponds to a transaction category); (iv) terminal product identifier data that identifies a product, service, or other subject of the transfer instruction (i.e., the reason resources were being demanded, expended, or utilized); or (v) terminal location data corresponding to a geographic location where the terminal computing device is located. The terminal data can be transmitted to the provider computing system separately from the transfer instruction or appended to the transfer instruction prior to sending the transfer instruction to the provider system.

The Transfer Monitor software service retrieves data from the Transfer Instruction Parameters database to process the transfer instruction. The Transfer Monitor software service can be implemented with a combination of a rules-based software engine that follows particular sequences of operations when processing data and one or more neural network architectures that implement machine learning and artificial intelligence technology. The Transfer Monitor software service can incorporate multiple neural networking architectures depending on the operations to be executed, such as relying on a first neural network to perform operations that classify events and data and a second neural network to perform operations that make predictions about future transfer instructions and transactions.

The Transfer Monitor software are service performs a transfer analysis to generate the data included within the product utilization messages. The transfer analysis itself can include performing various sub-categories of analyses using sources of data that include transfer data from the Transfer Activity Database, a transfer instruction, transfer instruction parameters, and end user data from the End User Database. Subcategories of analyses can include executing operations that implement a transfer condition activity analysis, a threshold analysis, a transfer predictive analysis, and a modification analysis.

The product utilization messages include content data that addresses categories of outputs that include, but are not limited to: (i) transfer activity data determined from a transfer condition activity analysis, which is used to generate messages that report certain resource transfer activity based on the occurrence of specified events or conditions; (ii) threshold activity data determined from a threshold analysis, which is used to generate messages that report transfer activity that exceeds or falls below specified thresholds; (iii) predictive transfer data determined from a transfer predictive analysis, which is used to generate messages that report future, expected resource transfer activity; and (iv) modification data determined from a modification analysis, which is used to generate messages that recommend to users potential modifications to product utilization or transfer activity directed to optimizing product utilization. Skilled artisans will recognize that the above example analyses and output categories are not intended to be limiting, and the provider system could be designed to generate product utilization messages that address other categories of outputs, such as messages that recommend transfers or other activities that save users time or that address subjective user preferences, such as recreational activity preferences.

With respect to transfer activity data, the transfer analysis is configured to analyze incoming or outgoing transfer instructions to recognize and report on the occurrence of specified conditions. The conditions can be specified by the transfer instruction parameters stored to the Transfer Instruction Parameter database. The transfer condition activity analysis can be implemented through a rule-based software engine that processes each incoming transfer instruction using the transfer instruction parameters.

Application of the transfer condition activity analysis can be illustrated with the following examples. The transfer instruction parameters can include specifying a terminal source identification (e.g., a specific merchant to which payment is made, or customer from which payment is expected). In that case, the transfer condition activity analysis processes each transfer instruction to determine whether the transfer instruction includes the specified terminal source identification. When the terminal source identification is recognized, the Transfer Monitor software application (or another software application integrated with, or interfacing with, the provider system) generates a product utilization message that includes content data notifying a user that a transaction has occurred involving the specified terminal source identification.

The transfer condition activity analysis can also be configured to process transfer instructions using transfer data from the Transfer Activity Database. For instance, a user or provider might desire to monitor when the aggregate value of transactions from a particular source, or a particular category exceed a threshold value over a given time period (e.g., the value of all transactions with a given “Merchant A” or all transactions for “transportation expenses” exceed $1,000 in a month). The provider or user can use the Transfer Instruction Parameters GUI to specify: (i) a terminal source identification; (ii) transfer classification data; (iii) a transfer value threshold (i.e., a transfer amount above a specific threshold); and (iv) transfer event sequencing data specifying a duration of time.

Continuing with the foregoing example, when a transfer instruction is received, the Transfer Monitor software service retrieves the unique user identifier as well as the terminal source identification data and/or terminal source categorization data. The foregoing retrieved data is passed as part of a query to the Transfer Activity Database. The Transfer Activity Database returns data from transfer database records that comprises (i) the unique user identifier, (ii) and utilization value data associated with (iii) a particular terminal source identification and/or (iv) associated with transfer classification data, and (v) that falls within a time duration specified by the transfer event sequencing data from the transfer instruction parameters. The amount of the utilization value data from the transfer database records is aggregated and added to the transfer value data from the transfer instruction. The transfer condition activity analysis compares the total aggregated resource and transfer value data against a transfer value threshold specified as part of the Transfer Instruction Parameters to determine whether the threshold is exceeded for the particular terminal source identification and/or the source categorization data over the specified time. When the threshold is exceeded, the Remote Monitor software service generates a product utilization message that is transmitted to the user computing device for display.

The transfer condition activity analysis can be configured to recognize combinations of conditions. For instance, the transfer instruction parameters can include specifying (i) a terminal source identification as well as (ii) a transfer value threshold (i.e., a transfer amount above a specific threshold) and (iii) and polarity data (e.g., a net positive receipt of resources into a user account, such as an incoming payment). In this case, the transfer condition activity analysis processes incoming transfer instructions to determine if the transfer originated from a specific source, was above a specific value, and was a net positive resource transfer.

The above combination of conditions, specified by the transfer instruction parameters, could be recognized by a user as a paycheck from an employer (i.e., the source and expected amount is known to the user, and the user knows it will be a receipt of funds, not an expense). The combination of conditions could also be recognized by the user as an anticipated customer payment or a refund, which the user or provider configured the provider system to recognize by inputting transfer instruction parameters into the Transfer Instruction Parameters GUI. When the combination of conditions is recognized, the Transfer Monitor software service can generate a product utilization message that is transmitted to the user computing device for display.

The above examples are not intended to be limiting, and the transfer condition activity analysis can be configured to recognize a wide variety of other conditions present in the transfer instructions. A few additional examples include configuring the transfer condition activity analysis to determine: (i) when a transaction is complete and the transfer instructions have been implemented (e.g., a check or wire transfer has “cleared”); or (ii) if a transaction was denied and the transfer instructions were not implemented (e.g., a payment was denied for insufficient funds or suspected fraud).

In other embodiments, the provider system can be pre-programmed, without user input, to analyze transfer instructions to recognize the occurrence of certain conditions. For instance, the transfer condition activity analysis can be configured to determine whether an incoming transfer instruction represents a duplicate transaction. The transfer condition activity analysis captures data from the transfer instruction, such as the transfer value data, account identification data, the unique user identifier data, and a terminal source identification. The data captured from the transfer instruction is compared against data from the Transfer Activity Database to determine whether any of the transfer database records includes matching data. If a match is identified, the Transfer Monitor software service generates a product utilization message that includes content data indicating a potential duplicate transfer.

With respect to the threshold analysis, the transfer analysis is configured to first classify a particular transaction before determining expected future resource transfer data. The provider system then analyzes the transfer instruction to determine if the expected transfer data is present in the actual data received as part of the transfer instruction. The classification and expected data can be determined using artificial intelligence technology implemented through one or more neural networks.

Implementation of the threshold analysis is illustrated with the following examples. In one embodiment, the Transfer Monitor software service receives an incoming transfer instruction and retrieves the unique user identifier from the transfer instruction. The Transfer Monitor transmits a query to the Transfer Activity Database that includes the unique user identifier, and in return, receives transfer database records corresponding to, or associated with, the unique user identifier. The Transfer Monitor software service executes a transfer classification analysis using the transfer instructions and the transfer database records. The classification analysis generates transfer classification data and can be executed using neural network technologies, such as a convolutional neural network, a LDA neural network, or other neural network architectures configured to perform classification analyses.

The resulting transfer classification data from the transfer classification analysis might indicate, for instance, that the transfer instruction represents a subscription service expense or a paycheck from an employer based on an analysis of past transfer database records. The Transfer Monitor software service further determines expected transfer value data, such as an expected amount of the charge or payment. The expected transfer value data can be determined by averaging the utilization value data from the transfer database records. Alternatively, the expected transfer value data can be determined using neural network technology where, for instance, the utilization value data is not a consistent amount per period or per transaction but is instead subject to variation, such as seasonal variation or variation with other factors like user resource availability (e.g., an expense that varies with user income or market factors). In that case, neural network technologies are well adapted to recognize correlation between variables to render accurate data predictions.

Continuing with the above example, the expected transfer value is compared against the transfer value data from the transfer instruction. If the variation is above (or below) a predetermined threshold, the Transfer Monitor software service generates content data indicating an observed upward deviation in an expected subscription expense, and the content data is transmitted to the user computing device for display within a product utilization message. As another example, the comparison could recognize a downward deviation from an expected transfer value threshold, such as a paycheck or customer payment being too low.

The permitted deviation threshold can be determined by provider or input from a user in the form of a transfer instruction parameter entered into the Transfer Instruction Parameters GUI. The permitted deviation threshold could be represented as a quantitative amount (e.g., $10) or as a percentage variation from the expected data (e.g., 20% deviation between the expected transfer value data and the transfer value data in the received transfer instruction).

With respect to the transfer prediction analysis, the transfer analysis can be configured to render predictions concerning future transfer instructions and transfer activity. The predictions can be included as content data within the product utilization messages to provide users with information concerning potential future transfers. The transfer prediction analysis can be implemented with neural network technology that is configured to analyze past transactions to render predictions concerning future expected transactions. The transfer prediction analysis can also rely on neural network technology to perform a transfer classification analysis on expected future transfer instructions to facilitate user's ability to take action relating to expected future transfer activity.

Implementation of the transfer prediction analysis can be better understood with the following simplified examples. Prior to, or contemporaneously with, a user authenticating to a provider system, the Transfer Monitor software service can be configured to execute a transfer prediction analysis that includes a transfer classification analysis. The transfer prediction analysis utilizes the transfer database records as input for the analysis. The output of the transfer prediction analysis can be a list of potential transfer instructions that the provider system could expect to receive where the transfer instructions includes, without limitation: (i) transfer value data; (ii) transfer instruction sequencing data (i.e., an expected date the transfer instruction will be received); (iii) product identification data for an account that will receive or transfer resources; (iv) a terminal source identification that designates the source of the transfer; and (v) transfer classification data characterizing the expected transfer instruction.

The Transfer Monitor software service generates a product utilization message that includes the expected transfer instructions. The product utilization message is transmitted to a user computing device and displayed to the user. The Transfer Monitor software service can execute additional operations to yield content data for display as part of the product utilization message along with the predictive transfer data. For instance, the Transfer Monitor software service can aggregate the transfer value data from the expected transfer instructions and compare the aggregated transfer value data against the resource availability data for a corresponding user account. In this manner, the Transfer Monitor software service can determine if the user account includes sufficient resources to meet expected future demand, and if not, display a notification to the user within the product utilization message.

As another example, the transfer classification analysis could output transfer classification data that characterizes an expected transfer instruction as an annual subscription payment for an underlying service. The product utilization message could include content data notifying the user that the annual subscription payment will soon be due and payable. This in turn permits the user an opportunity to evaluate the underlying service and determine whether product utilization can be optimized by terminating or modifying the service.

With respect to the modification analysis, the transfer analysis can be configured to render transfer modification data that recommends activities that users can perform to optimize product utilization. The modification analysis can process incoming transaction instructions, transfer database records from the Transfer Activity Database, end user data from the End User Database, and the results of other components of the transfer analysis. The modification analysis can be implemented with a rules-based software engine that outputs modification data depending on recognized input conditions or data. In some embodiments, the modification analysis can be implemented using neural network technology that outputs recommended product utilization modifications depending on the probabilities of potential outcomes as determined by the neural networks.

Implementation of the modification analysis can be better understood with the following simplified examples. In one embodiment, a transfer instruction could include transfer classification data or provider product identifier data indicating that the transfer instruction represents a debt payment for an account or product administered by the provider. The Transfer Monitor software service retrieves data from the Transfer Activity Database relating to product or account associated with the debt and transmits the data as part of a query to a Modification Database. In return, the Transfer Monitor software service receives modification data that includes potential modifications to the transfer value data in the transfer instructions. The potential modifications can be a recommended modification to the debt payments that would permit the user to pay off the debt sooner at a lower resource expenditure.

As another example, the transfer instructions could include transfer classification data, terminal location data, and/or terminal source identification data indicating that the transfer instruction represents a service fee for an automatic teller machine. The Transfer Monitor software service executes a transfer condition activity analysis to determine whether the transfer value data from the transfer instruction exceeds a specified threshold. If the transfer value data exceeds the specified threshold, the Transfer Monitor software service transmits a query to the Modification Database that can include terminal transfer classification data, terminal location data, and user computing device location data. In return, the Transfer Monitor software service receives modification data that includes the location of one or more automated teller machines that carry reduced service fees and that are proximal to the user computing device location.

The Transfer Monitor software service then generates a product utilization message that includes content data informing the user of the location of one or more automated teller machines that charge the reduced fees. The product utilization message thus provides the user with information that allows the user to optimize or conserve product utilization activities.

In another embodiment, the Transfer Monitor software service can execute a transfer classification analysis on an incoming transfer instruction, transfer database records, and end user data to determine that the transfer instruction represents a reoccurring, periodic insurance payment for a rental home in a given geographic location. The Transfer Monitor software service can execute a modification analysis relying on neural network technology that determines an output indicating that the transfer value data is likely to significantly increase for future transfer instructions relating to the same payment. The Transfer Monitor software service passes the result to the Modification Database and receives modification data recommending that the user cancel or modify the existing insurance service. The Transfer Monitor software service generates a product utilization message that includes the modification data for display on the user computing device.

### Product Utilization Message Display

The example product utilization messages shown in FIGS. 7-9 can be displayed as graphical widgets on a user computing device. The product utilization messages that are displayed on the user computing device can be filtered so as to vary in content and format according to the particular GUI that is being transmitted to the user computing device for display. That is, the types and substance of the messages, as well as the format, can vary depending on what graphical interface is being accessed by the user at the time. This ensures the most relevant messages are displayed to a user at a given time, thereby allowing users to more effectively and efficiently take action on the messages. Additionally, the positioning and format of the product utilization messages can also vary according to the priority of the messages as determined by a priority analysis that generates priority data as a measure of the relative importance of the product utilization message to a particular user.

Once generated, the product utilization messages can be stored to a Message Database on the provider's system. This can ensure the product utilization messages are available to be transmitted to, and displayed on, the user computing device from one login session to the next. Thus, the product utilization messages can be persistent rather than temporary, and the messages do not need to be newly generated each time a user logins into the provider computing system.

The utility of varying the product utilization message displays can be illustrated with the following representative examples. In one case, as illustrated in FIG. 8, when a user computing device authenticates to the provider system, a provider network computing device transmits interface display data to the user computing device to display a Homepage GUI. The provider system filters the available product utilization messages according to interface identification data indicating that the Homepage GUI should be transmitted to the user computing device for display. The interface display data transmitted to the user computing device can include data and instructions for displaying one or more utilization message previews, such as the resource message previous shown in FIG. 8. The utilization message previews and product utilization are displayed as graphical widgets on the Homepage GUI.

The resource message previous are displayed as associated with a particular user account. The message previews display category descriptor data, utilization value data, and abbreviated content data, such as the first line or first pre-selected number of words of a full product utilization message. The resource message previous can include an expander input function that displays a full product utilization message when selected by a user computing device, such as a “+” symbol that allows users to expand the current widget or a hyperlink that navigates the user computing device to a separate graphical interface that displays additional data relating to the product utilization message.

In short, the example Homepage GUI shown in FIG. 8 is configured to display multiple relevant but abbreviated product utilization messages associated with multiple accounts. This provides users with a broad array of information in a centralized location, and the information is presented in a preview format to facilitate efficient review. Further, users have a convenient mechanism to review additional d information concerning selected product utilization messages.

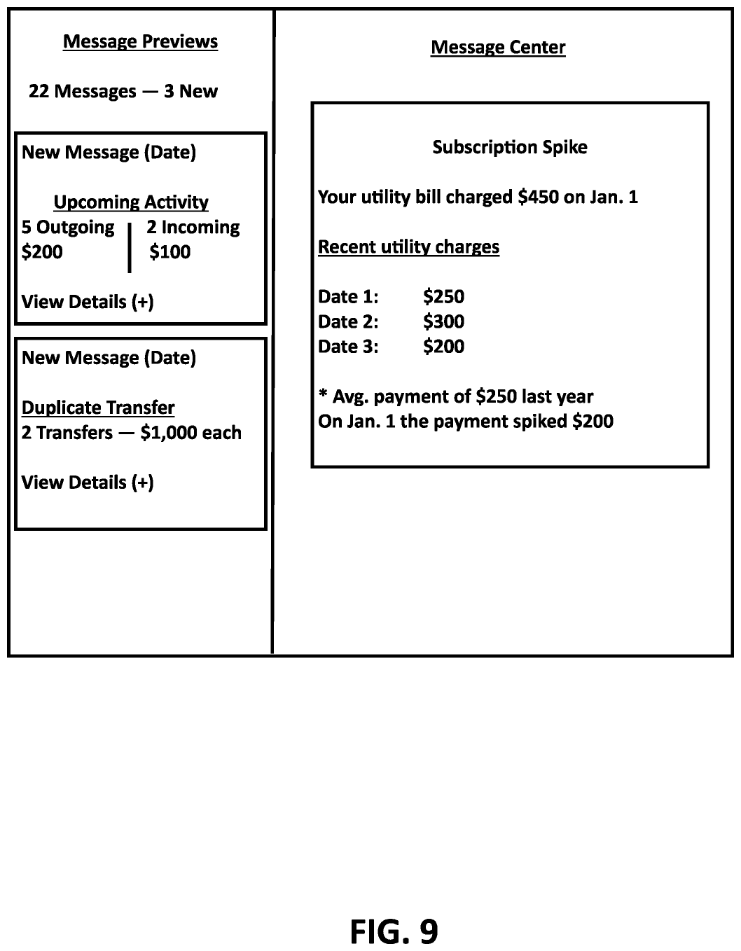

In another example shown in FIG. 9, a user accesses an Account Interface GUI for a specific user account. The user is presented with a product utilization message showing expected future resource transfer activity for the specific account, as determined by the transfer predictive analysis. The message content can also indicate whether the resource availability for the account is insufficient to meet expected future transfers (i.e., the account balance is too low). In that case, the user can be presented with an input function that allows the user to remediate the potential problem with resource availability. For instance, displaying a hyperlink that, when selected by the user, navigates the user computing device to a graphical interface having functions that allow the user to initiate a transfer of additional resources into the account sufficient to meet the demands of expected future transfer instructions.

As another example, a user computing device navigates to a graphical interface (i.e., a Resource Transfer GUI that allows a user to complete a transfer instruction, such as paying a utility service expense or making a payment on a residential loan product administered by the provider. Just prior to, contemporaneous with, or immediately after the interface display data is transmitted to the user computing device to display the Resource Transfer GUI, a provider network computing device can also transmit interface display data that includes product utilization message to display one or more relevant product utilization messages on the Resource Transfer GUI.

The product utilization message displayed on the Resource Transfer GUI could indicate, for example, that the utilization value data for the utility payment is above a specified threshold (i.e., the payment is unusually high as determined by the threshold analysis). Alternatively, the product utilization message could indicate that the utility payment, if completed, would represent a duplicate transaction, as determined by a transfer condition activity analysis. The product utilization message, therefore, allows users an opportunity to verify the utility payment transaction contemporaneous with the time the transaction is to be initiated.

When initiating a resource transfer for the residential loan payment, the user computing device could display a product utilization message that includes modification data representing a suggested modification to the value or sequence of future resource transfers or payments (as determined by the modification analysis). The product utilization message could further include an input function, such as a hyperlink, that navigates the user computing device to a graphical interface that permits the user to implement the recommendations underlying the modification data by modifying the amount and timing of future resource transfers.

The product utilization methods can also be displayed as graphical widgets in a frame adjacent to a centralized main frame on a graphical interface, as illustrated in FIG. 10. This allows users to continue navigating through various graphical interfaces of the provider system while ensuring that relevant product utilization messages and insights remain available for user review and, if needed, user action to remediate product utilization problems or inefficiencies.

By varying the product utilization messages according to the graphical interface displayed, the provider system analyzes substantial volumes of resource transfer data that could not ordinarily be analyzed in real-time by users and presents users with efficient and accessible graphical widgets that provide product utilization information and insights that are most relevant to a user's current activities. The system presents users with actionable insights based on an analysis of resource transfer data in a manner that allows users to expediently, effectively, and efficiently take action relating to the insights. The provider system automates the process of monitoring and managing the resource transfers and gives users much greater access to the resource transfer data as well as the underlying meaning and implications of the data.

An example process for implementing graphical display of the product utilization messages can be illustrated as follows. The user interface transmit command that is sent from a user computing device to the provider system can include interface identifier data that designates a specific interface page or GUI to be transmitted from a provider network computing device to the user computing device for display. Alternatively, the provider computing system itself can determine the specific GUI to be transmitted to the user computing device as part of the interface display data. For instance, upon successfully authenticating a user and/or user computing device, a provider network computing device can determine that interface display data for displaying a Homepage GUI should be transmitted to the user computing device. Or instead, the provider computing device might determine that upon authentication, a User Profile GUI should be transmitted to the user computing device for display where a particular user is required to modify end user data, such as changing a password or registering a new user computing device where the authentication process detects that a new computing device is being used.

The provider system filters available product utilization messages according to the interface identifier data. The interface display data transmitted to the user computing device can include one or more filtered and selected product utilization messages that vary according to the graphical interface that is transmitted for display. In one embodiment, the product utilization messages are transmitted as JavaScript Object Notation packets that have the advantages of being human readable, universal data structures that are compatible with a wide variety of programming languages.

After determining a GUI to be transmitted to the user computing device, the provider network computing device generates a database query that includes interface identifier data. The query is sent to the Message Database. In return, the provider network device receives one or more product utilization messages designated for display on the graphical interface corresponding to the interface identifier data.

To illustrate a product utilization message selection for display, a user can select a hyperlink on the user computing device to navigate to display an Account Interface GUI relating to a specific user account. Prior to transmitting display data to the user computing device, the provider network device sends a query to the Message Database that includes the unique user identifier and the account number at issue. In response the query, one or more product utilization messages are returned that have a matching unique user identifiers and the account number. Alternatively, upon selection of the Account Interface GUI for display, the provider system can execute a transfer analysis to generate product utilization messages for display that are relevant to the particular account being displayed. The provider system thus retrieves a subset of available product utilization messages that relate to the specific user account selected for display on the Account Interface GUI.

As another example, a user computing device can select an input function to display a Resource Transfer GUI for the purpose of initiating a resource transfer. The user enters data on the Resource Transfer GUI that includes specifying a terminal source identification that designates a third party to receive a transfer of resources. The user computing device or the provider computing device specify transfer classification data that indicates the category of products or services subject to the resource transfer.

In response to the Resource Transfer GUI being displayed, the provider system can execute a modification analysis to generate modification data that corresponds to a recommendation for the user to adjust the amount of the transfer in a manner that optimizes efficient resource utilization. Thus, the particular graphical interface being displayed (the Resource Transfer GUI) resulted in the provider system executing a specific type of analysis (i.e., a modification analysis) to customize the product utilization message displayed to the user.

Display of the product utilization messages has been described with reference to the display of graphical widgets within an Internet browser software application or a dedicated software application, such as a mobile app. Those of skill in the art will appreciate, however, that other message formats could be implemented. For example, in other embodiments, product utilization messages could be transmitted to a user computing device as a “push notification” that is displayed as a popup or displayed in a centralized location on a user device alongside other device notifications (e.g., displayed on a “message bar” at the top of a device display screen). In yet other embodiments, the product utilization messages could be transmitted to a user computing device through email or a SMS text message format in addition to being displayed as graphical widgets when a user accesses a provider system.

The product utilization messages can also be displayed in a manner that reflects a priority of the messages, as determined by a priority analysis. The priority of a product utilization message can be indicated by the position of the messages on a graphical interface, such as displaying higher priority messages in a higher position. Priority of a product utilization message could also be indicated through color-coding the messages (e.g., high priority messages are displayed with red or orange text), through movement (e.g., flashing text or graphics), sounds, or other suitable indicators that call user attention to a given message.

The priority analysis generates priority data and can be implemented through a rule-based software model in combination with artificial intelligence techniques. In one example embodiment, with respect to a rule-based approach, the provider system (such as the Transfer Monitor software service) can be configured to determine product utilization message priority through analysis of sequencing data. The priority analysis can utilize sequencing data to prioritize the display of product utilization messages that were generated most recently.

In another example, where product utilization messages are generated using a transfer predictive analysis and relate to expected future events, the messages can be prioritized according to the date of such future events. For instance, if the sequencing data for a product utilization message indicates that a transfer instruction relating to subscription payment is due or expected to occur in the near future, the message can be prioritized for display over other messages relating to later activity. In another example, if the product utilization message indicates that within one day, an expected transfer instructions will result in insufficient account resources for a critical transfer (e.g., an insufficient account balance to make a mortgage payment), the product utilization message can be prioritized above other messages that do not require future action on the part of the user.

As a further example, the priority analysis can generally be configured to prioritize product utilization messages that require user action over those messages that are more informative in nature but that do not necessarily require user action. For instance, the provider system might analyze a transfer instruction based on a paper check written by a user, and based on the check number identifier and historical user check orders, recognize that the user has nearly utilized all available checks. In that case, the provider system can generate a product utilization message indicating that the user is required to take action by ordering new checks. The product utilization message thus requires user action and can be prioritized over other messages that are information in nature, such as a message indicating that a refund was received.

In other embodiments, the priority analysis can utilize neural network technology to prioritize product utilization messages according to probabilities determined from an analysis of transfer data and end user activity data. For instance, the activity data could include information relating to prior product utilization messages that a user has selected for further review or to take further action, such as messages relating to expected resource transfers for subscription payments. Further, the navigation data could indicate that a user has increased Internet browsing activity relating to one or more subscription services. In that case, those factors would weigh more significantly in a neural network executing a priority analysis and yield outputs with higher probabilities that a user is likely to select product utilization messages that relate to expected subscription payments. In that case, such product utilization messages are prioritized.

For some embodiments, the priority analyze can be configured to utilize machine learning technology to analyze end user data, transfer data, and activity from a large number of users to determine that particular demographics of users are more likely to select particular types of product utilization messages for review. For instance, the priority analysis could determine that younger users of modest income are more likely to view product utilization messages relating to expected future transactions while older users with higher incomes are more likely to select messages that relate to past transfer instructions, such as notifications of completed transfers. In that case, upon login by a particular user, the provider system can retrieve end user data for the particular user and run a priority analysis that results in prioritization of product utilization messages for display depending on the age or income of the user.

Skilled artisans will appreciate that the above priority analysis examples are not intended to be limiting, and a wide variety of other data could factor into a priority analysis depending on the results of neural network processing. Examples include, but are not limited to, prioritizing product utilization messages based on the types of account identifications associated with a given user, resource availability data, system configuration data, or other types of information discussed herein.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A system for generating a graphical user interface for display of transfer data messages comprising a network computing device, wherein the network computing device comprises one or more integrated software applications that perform the operations comprising:
(a) establishing a secure communication session between the network computing device and a user computing device;
(b) receiving by the network computing device, from the user computing device, both (i) an interface transmit command comprising interface identification data, and (ii) product identification data;
(c) passing the product identification data to a Transfer Activity Database and in return receiving transfer data for a plurality of transfers associated with the product identification data;
(d) executing a transfer analysis utilizing the transfer data, wherein the transfer analysis generates product utilization message data;
(e) generating a plurality of product utilization messages using the product utilization message data, wherein each product utilization message comprises utilization value data and message sequencing data;
(f) filtering the product utilization messages using the interface identification data, wherein one or more product utilization message are selected for transmission to the user computing device based on the interface identification data;
(g) executing a priority analysis that processes the product utilization message to generate priority data; and
(h) transmitting the selected product utilization messages and priority data to the user computing device for display, wherein (i) the user computing device displays both the utilization value data and the message sequencing data, and wherein (ii) the selected product utilization messages are displayed according to the priority data.

2. The system for generating a graphical user interface for display of transfer data messages of claim 1, wherein:
(a) the product utilization message data further comprises product identification data;
(b) the interface identification data designates an Account Interface GUI for display that is associated with a given product identification;
(c) filtering the product utilization messages comprises the operations of
(i) determining for each product utilization message, whether the product utilization message comprises product identification data that matches the given product identification, and
(ii) when the product identification data matches the given product identification, transmitting the product utilization message having matching data to the user computing device for display.

3. The system for generating a graphical user interface for display of transfer data messages of claim 1, wherein:
(a) the interface identification data designates a Homepage GUI for display;
(b) the one or more product utilization messages are displayed by the user computing device as utilization message previews comprising category descriptor data and utilization value data.

4. The system for generating a graphical user interface for display of transfer data messages of claim 1, wherein:
(a) the priority data comprises expected sequencing data that represents a time in the future that is later than priority data for previous active product utilization messages currently displayed by the user computing device;
(b) the product utilization message is displayed according to the priority data by selecting a position on a user computing device display screen to display the product utilization message, wherein the selected position is closer to the top of the display screen relative to previous active product utilization messages.

5. The system for generating a graphical user interface for display of transfer data messages of claim 1, wherein:
(a) the priority data for the product utilization message has a higher value than priority data for previous product utilization messages current displayed by the user computing device; and
(b) the product utilization message is displayed according to the priority data by selecting a position on a user computing device display screen to display the product utilization message, wherein the selected position is closer to the top of the display screen relative to previous active product utilization messages.

6. The system for generating a graphical user interface for display of transfer data messages of claim 4, wherein:
(a) the network computing device comprises a neural network; and
(b) the neural network is used to execute the priority analysis.

7. The system for generating a graphical user interface for display of transfer data messages of claim 6, wherein the neural network is a recurrent neural network having a long short-term memory neural network architecture.

8. The system for generating a graphical user interface for display of transfer data messages of claim 6, wherein the neural network comprises a convolutional neural network having least three intermediate layers.

9. The system for generating a graphical user interface for display of transfer data messages of claim 7, wherein the neural network performs operations that implement a Latent Dirichlet Allocation model.

10. The system for generating a graphical user interface for display of transfer data messages of claim 1, wherein the product utilization messages are displayed as graphical widgets on the user computing device.

11. The system for generating a graphical user interface for display of transfer data messages of claim 10, wherein the graphical widgets include an expansion input function that toggles display of the graphical widget between a full product utilization message view and a utilization message preview.

12. The system for generating a graphical user interface for display of transfer data messages of claim 11, wherein the product utilization messages are transmitted to the user computing device using JavaScript Object Notation messages.

13. The system for generating a graphical user interface for display of transfer data messages of claim 1, wherein:
(a) the network computing device executes a transfer predictive analysis utilizing transfer data retrieved from a Transfer Activity Database, wherein
(i) the transfer predictive analysis generates predictive transfer data associated with one or more expected transfers, and wherein
(ii) for each expected transfer, the predictive transfer data comprises (A) expected transfer value data, (B) expected sequencing data, and (C) an expected terminal source identification; and
(b) the predictive transfer data is transmitted to the user computing device for display with the product utilization message.

14. A system for generating a graphical user interface for display of transfer data messages comprising a network computing device, wherein the network computing device comprises one or more integrated software applications that perform the operations comprising:
(a) establishing a secure communication session between the network computing device and a user computing device;
(b) passing the product identification data to a Transfer Activity Database and in return receiving transfer data for a plurality of transfers associated with the product identification data;
(c) executing a transfer analysis utilizing the transfer data, wherein the transfer analysis generates product utilization message data;
(d) generating a plurality of product utilization messages using the product utilization message data, wherein each product utilization message comprises utilization value data and message sequencing data;
(e) filtering the product utilization messages using the interface identification data, wherein one or more product utilization message are selected for transmission to the user computing device based on the interface identification data;
(f) executing a priority analysis that processes the product utilization message to generate priority data; and
(g) transmitting interface display data to the user computing device, wherein the interface display data comprises
(i) alphanumeric content and graphical elements used to generate a resource management graphical user interface, and
(ii) selected product utilization messages and priority data, wherein
(A) the product utilization messages are transmitted to the user computing device using JavaScript Object Notation messages,
(B) the product utilization messages are displayed as graphical widgets by the user computing device and integrated with the resource management graphical user interface,
(C) the user computing device displays both the utilization value data and the message sequencing data, and
(D) the selected product utilization messages are displayed according to the priority data.

15. The system for generating a graphical user interface for display of transfer data messages of claim 14, wherein:
(a) the priority data comprises expected sequencing data that represents a time in the future that is later than priority data for previous active product utilization messages currently displayed by the user computing device; and
(b) the product utilization message is displayed according to the priority data by selecting a position on a user computing device display screen to display the product utilization message, wherein the selected position is closer to the top of the display screen relative to previous active product utilization messages.

16. The system for generating a graphical user interface for display of transfer data messages of claim 14, wherein:
(a) the priority data for the product utilization message has a higher value than priority data for previous product utilization messages current displayed by the user computing device; and
(b) the product utilization message is displayed according to the priority data by selecting a position on a user computing device display screen to display the product utilization message, wherein the selected position is closer to the top of the display screen relative to the previous active product utilization messages.

17. The system for generating a graphical user interface for display of transfer data messages of claim 14, wherein the graphical widgets include an expansion input function that toggles display of the graphical widget between a full product utilization message view and a utilization message preview.

18. A system for generating a graphical user interface for display of transfer data messages comprising a network computing device, wherein the network computing device comprises one or more integrated software applications that perform the operations comprising:
(a) establishing a secure communication session between the network computing device and a user computing device;
(b) passing the product identification data to a Transfer Activity Database and in return receiving transfer data for a plurality of transfers associated with the product identification data;
(c) executing a transfer predictive analysis utilizing transfer data retrieved from a Transfer Activity Database, wherein
(i) the transfer predictive analysis generates predictive transfer data associated with one or more expected transfers, and wherein
(ii) for each expected transfer, the predictive transfer data comprises (A) expected transfer value data, (B) expected sequencing data, and (C) an expected terminal source identification;
(d) generating a product utilization messages using the predictive transfer data;
(e) executing a priority analysis that processes the product utilization message to generate priority data; and
(f) transmitting interface display data to the user computing device, wherein the interface display data comprises
(i) alphanumeric content and graphical elements used to generate a resource management graphical user interface, and
(ii) the product utilization message and priority data, wherein
(A) the product utilization message is displayed as a graphical widget by the user computing device and integrated with the resource management graphical user interface, and
(B) the product utilization message is displayed using the priority data.

19. The system for generating a graphical user interface for display of transfer data messages of claim 18, wherein:
(a) the network computing device comprises a neural network; and
(b) the first neural network is used to execute the transfer predictive analysis.

20. The system for processing transfer data of claim 19, wherein the neural network comprises a network architecture selected from one of a (i) LSTM network architecture, (ii) deep-learning, cyclic recurrent neural networks, (iii) Elman recurrent neural network, (iv) convolutional neural network, (v) multilayer perceptron network, (vi) TensorFlow network, (vii) MxNet network, (viii) PyTorch network, (ix) Keras network, or (x) Gluon network.
